(19) United States
(12) Patent Application Publication
(10) Pub. No.: US 2025/0254605 A1
(43) Pub. Date: Aug. 7, 2025

(54) RELAY COMMUNICATION METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Wei LU, Beijing (CN)

(21) Appl. No.: 18/856,853

(22) PCT Filed: Apr. 18, 2022
(86) PCT No.: PCT/CN2022/087316

§ 371 Date: Oct. 14, 2024

(51) Int. Cl. H04W 48/10; H04L 9/32; H04W 12/106; H04W 88/04

(52) U.S. Cl. CPC H04W 48/10; H04L 9/32; H04W 12/106; H04W 88/04

(57) ABSTRACT

A relay communication method, performed by first user equipment (UE), includes: sending a first request message to a first access and mobility management function (AMF), where the first request message is used to request security information for relay communication discovery between the first UE and second UE, the first request message includes first identification information of the first UE, and the first identification information is used by the first AMF to send second request information for requesting the security information to a first policy control function (PCF) corresponding to the first UE.

### CROSS-REFERENCE

The present application is a U.S. National Stage of International Application No. PCT/CN2022/087316, filed on Apr. 18, 2022, the contents of which are incorporated herein by reference in their entirety for all purposes.

### BACKGROUND OF THE INVENTION

In relay communication, when remote user equipment (remote UE) cannot communicate with a network due to network signal coverage or other reasons, a relay function of relay UE, such as UE-to-network (U2N) relay can be used to continue communication with the network. In a scenario, information that needs to be transmitted to the network may be first transmitted to the relay UE by the remote UE, and then the information is transmitted to the network by the relay UE; or, the information that needs to be transmitted to the remote UE may be first transmitted to a relay terminal by the network, and then the information is transmitted to the remote UE by the relay UE, thus communication between the remote UE and the network is achieved.

### SUMMARY OF THE INVENTION

Examples of the disclosure disclose a relay communication method and apparatus, a communication device, and a storage medium.

According to a first aspect of the disclosure, a relay communication method is provided, performed by first UE, and includes:
sending a first request message to a first access and mobility management function (AMF), where the first request message is used to request security information for relay communication discovery between the first UE and second UE, the first request message includes first identification information of the first UE, and the first identification information is used by the first AMF to send second request information for requesting the security information to a first policy control function (PCF) corresponding to the first UE.

According to a second aspect of the disclosure, a relay communication method is provided, performed by a first AMF, and includes:
receiving a first request message sent by first UE, where the first request message is used to request security information for relay communication discovery between the first UE and second UE; and
sending, based on first identification information of the first UE carried in the first request message, a second request message for requesting the security information to a first PCF corresponding to the first identification information.

According to a third aspect of the disclosure, a relay communication method is provided, performed by a first PCF, and includes:
receiving a second request message, the second request message is sent by a first AMF according to the second aspect of the disclosure; and/or receiving a fourth request message sent by a second PCF, where the second request message and/or the fourth request message are/is used to request security information for relay communication discovery between first UE and second UE; the second PCF is a PCF corresponding to the second UE.

According to a fourth aspect of the disclosure, a relay communication method is provided, performed by a network device, and includes:
acquiring a request message sent by UE, where the request message carries identification information of the UE, and the request message is used to request security information for relay communication discovery between the UE and UE; and
sending a response message carrying the security information to the UE.

According to a fifth aspect of the disclosure, a communication device is provided, and includes:
one or more processors; and
a memory, configured to store executable instructions of a processor, where
the executable instructions executed by the one or more processors causes the one or more processors are collectively configured to perform the relay communication method according to the example of the first aspect of the disclosure.

According to a sixth aspect of the disclosure, a non-transitory computer storage medium is provided. A computer executable program is stored in the non-transitory computer storage medium. The executable program, when executed by one or more processors, cause the one or more processors to collectively perform the relay communication method according to the example of the first aspect of the disclosure.

It needs to be understood that the above general descriptions and the following detailed descriptions are merely schematic and explanatory, and cannot limit the examples of the disclosure.

### BRIEF DESCRIPTION OF DRAWINGS

FIG. 1 is a schematic structural diagram of a wireless communication system shown according to an example.

FIG. 2 is a flow diagram of a UE-to-network relay discovery method with a model A shown according to an example.

FIG. 3 is a flow diagram of a UE-to-network relay discovery method with a model B shown according to an example.

FIG. 4 is a flow diagram of a relay communication method shown according to an example.

FIG. 5 is a flow diagram of a relay communication method shown according to an example.

FIG. 6 is a flow diagram of a relay communication method shown according to an example.

FIG. 7 is a flow diagram of a relay communication method shown according to an example.

FIG. 8 is a flow diagram of a relay communication method shown according to an example.

FIG. 9 is a flow diagram of a relay communication method shown according to an example.

FIG. 10 is a flow diagram of a relay communication method shown according to an example.

FIG. 11 is a flow diagram of a relay communication method shown according to an example.

FIG. 12 is a flow diagram of a relay communication method shown according to an example.

FIG. 13 is a flow diagram of a relay communication method shown according to an example.

FIG. 14 is a flow diagram of a relay communication method shown according to an example.

FIG. 15 is a flow diagram of a relay communication method shown according to an example.

FIG. 16 is a block diagram of a relay communication apparatus shown according to an example.

FIG. 17 is a block diagram of a relay communication apparatus shown according to an example.

FIG. 18 is a block diagram of a relay communication apparatus shown according to an example.

FIG. 19 is a block diagram of a relay communication apparatus shown according to an example.

FIG. 20 is a block diagram of a relay communication apparatus shown according to an example.

FIG. 21 is a block diagram of a relay communication apparatus shown according to an example.

FIG. 22 is a block diagram of a relay communication apparatus shown according to an example.

FIG. 23 is a block diagram of UE shown according to an example.

FIG. 24 is a block diagram of a base station shown according to an example.

### DETAILED DESCRIPTION OF THE INVENTION

Examples will be illustrated in detail here, and instances of which are represented in the accompanying drawings. When the following descriptions refer to the accompanying drawings, the same number in the different accompanying drawings represents the same or similar elements unless otherwise indicated. The implementations described in the following examples do not represent all implementations consistent with the examples of the disclosure. On the contrary, they are merely examples of an apparatus and method consistent with some aspects of the examples of the disclosure as detailed in the appended claims.

Terms used in the examples of the disclosure are merely for the purpose of describing the particular examples, and are not intended to limit the examples of the disclosure. The singular forms “a” and “this” used in the examples of the disclosure and the appended claims are intended to include the plural forms as well, unless the context clearly indicates otherwise. It is to be further understood that a term “and/or” used in this text refers to and contains any and all possible combinations of one or more associated listed items.

It is to be understood that the terms “first”, “second”, “third” and the like may be employed in the examples of the disclosure to describe various information, but these pieces of information should not be limited to these terms. These terms are merely used to distinguish the same type of information from one another. For example, in a case of not departing from the scope of the examples of the disclosure, first information may also be called second information, and similarly, the second information may also be called the first information. Depending on the context, the word “if” as used here may be interpreted as “at the time of” or “when” or “in response to determining”.

The disclosure relates to but is not limited to the technical field of communications, in particular to a relay communication method and apparatus, a communication device, and a storage medium.

In related art, during a process of relay communication discovery, a discovery message transmitted between the remote UE and the relay UE lacks security protection. For example, the discovery message needing to be transmitted between the remote UE and the relay UE lacks security protection, which has potential security hazards.

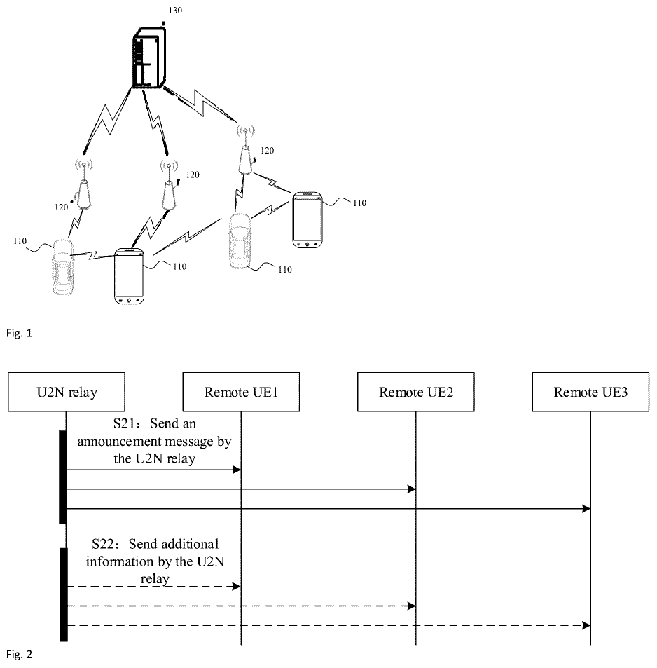

Please refer to FIG. 1, and FIG. 1 shows a schematic structural diagram of a wireless communication system provided by an example of the disclosure. As shown in FIG. 1, the wireless communication system is a communication system based on a cellular mobile communication technology, and the wireless communication system may include: a plurality of user equipment 110 and a plurality of base stations 120.

The user equipment 110 may refer to a device that provides voice and/or data connectivity for a user. The user equipment 110 may communicate with one or more core networks via a radio access network (RAN), and the user equipment 110 may be Internet-of-Thing user equipment, such as a sensor device, a mobile phone (or called a “cellular” phone) and a computer with the Internet-of-Thing user equipment, for example, may be fixed, portable, pocket-sized, hand-held, computer-built or vehicle-mounted apparatuses. For example, the user equipment may be a station (STA), a subscriber unit, a subscriber station, a mobile station, a mobile, a remote station, an access point, remote user equipment (remote terminal), access user equipment (access terminal), a user apparatus (user terminal), a user agent, a user device, or the user equipment. Alternatively, the user equipment 110 may also be a device of an unmanned aerial vehicle. Alternatively, the user equipment 110 may also be a vehicle-mounted device, for example, the user equipment may be a trip computer with a wireless communication function, or wireless user equipment externally connected to the trip computer. Alternatively, the user equipment 110 may also be a roadside device, for example, may be a streetlight, a signal light, or other roadside devices with the wireless communication function.

The base station 120 may be a network-side device in the wireless communication system. The wireless communication system may be the 4th generation mobile communication (4G) system, also known as a long term evolution (LTE) system; alternatively, the wireless communication system may also be a 5G system, also known as a new radio system or a 5G NR system. Alternatively, the wireless communication system may also be the next-generation system of the 5G system. An access network in the 5G system may be called a new generation-radio access network (NG-RAN).

The base station 120 may be an evolved base station (eNB) used in the 4G system. Alternatively, the base station 120 may also be a base station (gNB) that adopts a centralized distributed architecture in the 5G system. In response to determining that the base station 120 adopts the centralized distributed architecture, the base station usually includes a central unit (CU) and at least two distributed units (DU). The central unit is provided with protocol stacks of a packet data convergence protocol (PDCP) layer, a radio link control (RLC) protocol layer, and a medium access control (MAC) layer; and the distributed unit is provided with a physical (PHY) layer protocol stack. The specific implementation of the base station 120 is not limited in the example of the disclosure.

A wireless connection may be established between the base station 120 and the user equipment 110 through a wireless radio. In different implementations, the wireless air interface is a wireless air interface based on the 4th generation mobile communication network technology (4G) standard; alternatively, the wireless air interface is a wireless air interface based on the 5th generation mobile communication network technology (5G) standard, for example, the wireless air interface is a new radio; alternatively, the wireless air interface may also be a wireless air interface based on a next generation of 5G mobile communication network technology standard.

In some examples, an end to end (E2E) connection may also be established between the pieces of user equipment 110, for example, vehicle to vehicle (V2V) communication, vehicle to infrastructure (V21) communication, vehicle to pedestrian (V2P) communication and other scenarios in vehicle to everything (V2X) communication.

Here, the above user equipment may be regarded as terminal equipment of the following examples.

In some examples, the above wireless communication system may further contain a network management device 130.

The plurality of base stations 120 are respectively connected with the network management device 130. The network management device 130 may be a core network device in the wireless communication system. For example, the network management device 130 may be a mobility management entity (MME) in an evolved packet core (EPC) network. Alternatively, the network management device may also be other core network devices, such as a serving gateway (SGW), a public data network gateway (PGW), a policy and charging rules function (PCRF) or a home subscriber server (HSS). An implementation form of the network management device 130 is not limited in the examples of the disclosure.

In order to facilitate the understanding of those skilled in the art, a plurality of implementations are listed in the examples of the disclosure to clearly illustrate the technical solutions of the disclosure. Certainly, those skilled in the art may understand that the plurality of examples provided by the examples of the disclosure may be performed separately, or performed together after being combined with the methods of other examples in the examples of the disclosure, or performed separately or performed together with some methods in other related art after combination, which is not limited in the examples of the disclosure.

In order to better understand the technical solutions described in any of the examples of the disclosure, relay communication in the related art is partially illustrated first:
in an example, solutions in terms of a control plane and a user plane are provided for UE-to-network relay. For the solutions based on the user plane, a 5G proximity-based service (ProSe) key management function (PKMF) is used to support secure key management for PC5 connections of 5G ProSe indirect or relay communication. In a security process of the 5G proximity-based service, a direct discovery name management function (DDNMF) is introduced, and the DDNMF generates and provides essential discovery security parameters for the proximity-based service. The DDNMF is a logical function for allocating and parsing mapping between a proximity-based service application ID and the proximity-based service application or a restricted code for dynamic 5G proximity-based service direct discovery. However, the DDNMF does not necessarily involve UE-to-network (U2N) relay discovery of the 5G proximity-based service, and does not require the allocation and resolution of mapping between the proximity-based service application ID and the proximity-based service application ID or the restricted code.

In an example, for the UE-to-network (U2N) relay discovery, the UE pre-configures or provides discovery parameters using a policy control function (PCF) during service authorization and information provision. At present, the discovery parameters provided by the PCF to the UE are defined to include security-related content for the 5G proximity-based service U2N discovery for each relay service code (RSC) of the proximity-based service.

In an example, a approach of a model A is provided to support the UE-to-network relay discovery; and the model A uses a single discovery protocol message (such as an announcement message). As shown in FIG. 2, the approach of the model A is performed by a communication device, and the communication device includes remote UE and a U2N relay, where, the remote UE includes remote UE1, remote UE2, and remote UE3; and the UE-to-network relay discovery method through the model A includes the Step S21-Step S22.

Step S21: an announcement message is sent by the U2N relay. Here, the announcement message is sent by the U2N relay, and the announcement message may be monitored by the remote UE1, the remote UE2, and the remote UE3.

In some example, step S22: additional information is sent by the U2N relay. Here, the additional information is sent by the U2N relay, and the additional information may be monitored by the remote UE1, the remote UE2, and the remote UE3.

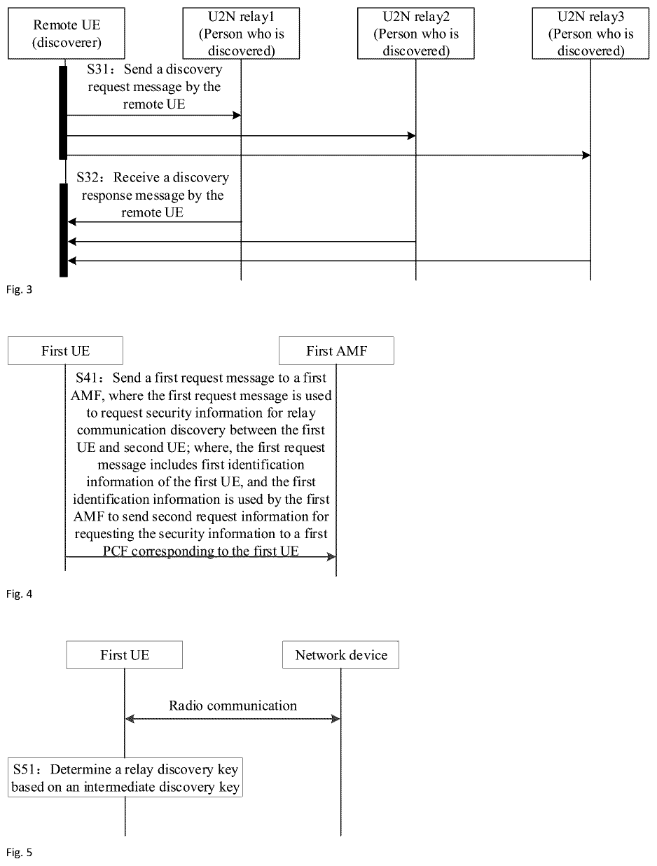

In another example, a approach of a model B is provided to support the UE-to-network relay discovery; and the model B uses two discovery protocol messages (such as a request message and a response message). As shown in FIG. 3, the approach of the model B is performed by a communication device, and the communication device includes remote UE and a U2N relay, where, the U2N relay includes a U2N relay 1, a U2N relay 2, and a U2N relay 3; and the UE-to-network relay discovery method through the model B includes the Step S31-Step S32.

Step S31: a discovery request message is sent by the remote UE.

Here, the discovery request message is sent by the remote UE, and the discovery request message may be monitored by the U2N relay 1, the U2N relay 2, and the U2N relay 3.

Step S32: a discovery response message is received by the remote UE.

Here, the discovery response message may be determined by the U2N relay 1, the U2N relay 2, and the U2N relay 3 based on the discovery request message, and is sent; and the discovery response message sent by the U2N relay 1, the U2N relay 2, and/or the U2N relay 3 may be monitored by the remote UE.

As shown in FIG. 4, an example of the disclosure provides a relay communication method, performed by first UE, and including the Step S41

Step S41: a first request message is sent to a first AMF, where the first request message is used to request security information for relay communication discovery between the first UE and second UE, the first request message includes first identification information of the first UE, and the first identification information is used by the first AMF to send second request information for requesting the security information to a first PCF corresponding to the first UE.

In the example of the disclosure, the UE involved may be, but is not limited to, a mobile terminal or a fixed terminal. For example, both the first UE and the second UE in the following examples may be, but are not limited to, a mobile phone, a computer, a server, a wearable device, a game control platform, or a multimedia device, etc. In an example, the first UE may be relay UE, and the second UE may be remote UE. Here, the relay UE may be 5G relay UE or 6G relay UE, etc. Here, the relay UE may be a U2N relay.

In the example of the disclosure, the first AMF, a second AMF, the first PCF, and a second PCF involved may be, but are not limited to, a core network device or a core network element or function, etc. The first AMF, the second AMF, the first PCF, and the second PCF may all be replaced by other core network devices or core network elements or functions with the same function. In an example, the first AMF may be an AMF of the relay UE; the second AMF may be an AMF of the remote UE; the first PCF may be a PCF of the relay UE; and/or the second PCF may be a PCF of the remote UE.

Here, the first identification information may be used to identify the first UE.

In an example, the first identification information includes at least one of the following:
a subscription concealed identifier (SUCI), or
a globally unique temporary UE identity (GUTI);
here, the second request message is used to request security information for relay communication discovery between the first UE and the second UE.

In an example, second identification information of the first UE is carried in the second request message. The second identification information may be used to identify the first UE.

In an example, the second identification information includes a subscription permanent identifier (SUPI) corresponding to the first identification information.

Here, a first mapping relationship is stored in the first AMF; and the first mapping relationship includes a correspondence between the first identification information and the second identification information. For example, the first mapping relationship includes a correspondence between the SUCI and the SUPI, and/or a correspondence between the GUTI and the SUPI. In this way, the SUPI of the first UE may be determined by the first AMF based on the SUCI and/or the SUPI of the first UE. In this way, the first AMF may know which first UE send the first request message and send the second request message to the first PCF corresponding to the first UE.

An example of the disclosure provides a relay communication method, performed by first UE, and including:
a first response message sent by a first AMF is received, where the first response message includes: security information included in a second response message, and the second response message is sent by a first PCF based on second identification information of the first UE included in the second response message.

In an example, the first request message includes: a message related to key request; the first response message includes: a message related to key response; and the security information includes: an intermediate discovery key.

In other examples, the security information may be any type of security protection information for protecting relay communication discovery protection between the first UE and second UE.

Here, the second request message may include the message related to key request. In an example, the difference between the first request message and the second request message is that the first identification information is carried in the first request message; and the second identification information is carried in the second request message.

Here, the second response message may include the message related to key response. In an example, the difference between the first response message and the second response message is that the second identification information is carried in the second response message; and the first identification information is carried in the first response message or the first identification information and the second identification information are not carried in the first response message.

In the example of the disclosure, the first request message may be sent to the first AMF through the first UE, where the first request message is used to request security information for relay communication discovery between the first UE and the second UE, the first request message includes the first identification information of the first UE, and the first identification information is used by the first AMF to send the second request information for requesting the security information to the first PCF corresponding to the first UE. In this way, when the relay communication discovery is performed between the first UE and the second UE, security protection may be performed based on this security information. In this way, compared to a approach of not being able to perform security protection during the relay communication discovery, the relay communication discovery between the first UE and the second UE may be made more secure. Moreover, since the first identification information of the first UE is carried in the first request message, the first AMF may be made to accurately know which first UE needs to acquire the security information for the relay communication discovery; and it is beneficial for the first AMF to obtain the security information and then send the same to the first UE.

In the example of the disclosure, the first response message sent by the first AMF may be received through the first UE, where the first response message includes: the security information included in the second response message, and the second response message is sent by the first PCF based on the second identification information of the first UE included in the second response message. In this way, the security information determined by the first PCF may be forwarded through the first AMF to make the first UE to obtain the security information for relay communication discovery between the first UE and the second UE, thus the security of relay communication discovery between the first UE and the second UE is improved. Moreover, since the second identification information is carried in the second response message, it may also make the first AMF to accurately know which first UE needs to request the security information, and accurately forward the security information to the first UE that needs to obtain the security information.

In some examples, the message related to key request includes: an RSC indicating a relay service; and
the message related to key response includes: the intermediate discovery key for the RSC, or the intermediate discovery key for the RSC and identification information of the intermediate discovery key.

Here, different RSCs correspond to different intermediate discovery keys. For example, one RSC indicates one relay service; and one relay service corresponds to one intermediate discovery key.

For example, in response to determining that the message related to key response received by the first UE includes the intermediate discovery key of one RSC, it is determined that the intermediate discovery key is the intermediate discovery key for the relay service indicated by the RSC between the first UE and the second UE. In this way, in response to determining that the first UE merely requests the intermediate discovery key of one RSC, it may be acquired through the received intermediate discovery key.

For example, in response to determining that the message related to key response received by the first UE includes the intermediate discovery keys indicated by two or more than two RSCs and identification information of the intermediate discovery keys, the intermediate discovery key corresponding to any one of the RSCs may be determined through the identification information of the intermediate discovery keys. In this way, in response to determining that the first UE requests the intermediate discovery keys of the plurality of RSCs, the intermediate discovery key corresponding to any RSC may be accurately determined by obtaining the intermediate discovery keys of the plurality of RSCs and the identification information of the intermediate discovery keys. In some examples of the disclosure, the plurality is two or more than two.

In some examples, the message related to key request further includes at least one of the following:
a type indication information, used to indicate a type of a discovery message of relay communication; or
a first security indication information, used to indicate a security capability of the first UE.

Here, the type of the discovery message includes, but is not limited to: a direct discovery type or a relay discovery type. For example, the type indication information includes: first type indication information, used to indicate that the discovery message type is the direct discovery type; and second type indication information, used to indicate that the discovery message type is the relay discovery type.

Here, the first security indication information is used for the first PCF to determine an encryption/decryption algorithm and/or an integrity protection algorithm. The encryption/decryption algorithm and/or the integrity protection algorithm here may be an encryption/decryption algorithm and/or an integrity protection algorithm for the discovery message of relay communication.

In this way, in the example of the disclosure, by sending the message related to key request including the type indication information and/or the first security indication information, the type of the discovery message of relay communication and/or the encryption/decryption algorithm and the integrity protection algorithm for the discovery message of relay communication may be determined by the first PCF.

In some examples, the message related to key response further includes at least one of the following:
an algorithm identity, where the algorithm identity includes at least one of the following: a first algorithm identity, used to indicate an algorithm for encrypting and decrypting a discovery message of relay communication; or a second algorithm identity, used to indicate an algorithm for protecting integrity of the discovery message of relay communication; or
a time related information, used to determine whether the discovery message of relay communication is subjected to replay attack.

Here, the time related information includes, but is not limited to at least one of the following: a current time, maximum offset, or a validity timer.

Here, whether the received information (such as an announcement message) has been subjected to replay attack may be determined by the first UE based on the current time and the validity timer. For example, a discovery request message from the second UE is received by the first UE; if the first UE determines that the current time is not within a timing time of the validity timer, it may be determined that the discovery request message has been subjected to the replay attack; or, if it is determined that the current time is within the timing time of the validity timer, it may be determined that the discovery message has not been subjected to the replay attack. Or, a first time range is determined by the first UE based on the current time and the maximum offset, and/or based on a difference value between the current time and the maximum offset; if the first time range is not within the timing time of the validity timer, it may be determined that the discovery message has been subjected to the replay attack; or, if the first time range is within the timing time of the validity timer, it may be determined that the discovery message has not been subjected to the replay attack.

In the example of the disclosure, by receiving the message related to key response, forwarded by the first AMF and including one of the algorithm identity and the time related information, of the first PCF, the first UE may be made to acquire the encryption/decryption algorithm for encrypting or decrypting the discovery message, and the integrity protection algorithm, and/or determine whether the discovery message has been subjected to the replay attack. In this way, the security of relay communication discovery between the first UE and the second UE can be further improved.

An example of the disclosure provides a relay communication method, performed by first UE, and including: a first RSC set sent by a first AMF is received, where the first RSC set includes: at least one first RSC; and the first RSC is an RSC of a relay service that is able to be provided by the first UE.

Here, the first RSC set may be sent by a first PCF. Here, the first RSC set may also be sent by a DDNMF corresponding to the first UE.

In an example, discovery parameters carrying the first RSC set and sent by the first AMF are received by the first UE; and the discovery parameters are sent by the first PCF or the DDNMF corresponding to the first UE.

In this way, in the example of the disclosure, the first RSC set may be acquired from a core network element such as the first PCF through the first UE, and the relay service that may be provided by the first UE may be learned.

It is to be noted that those skilled in the art may understand that the method provided by the examples of the disclosure may be performed separately, or performed together with some methods in the examples of the disclosure, or some methods in the related art.

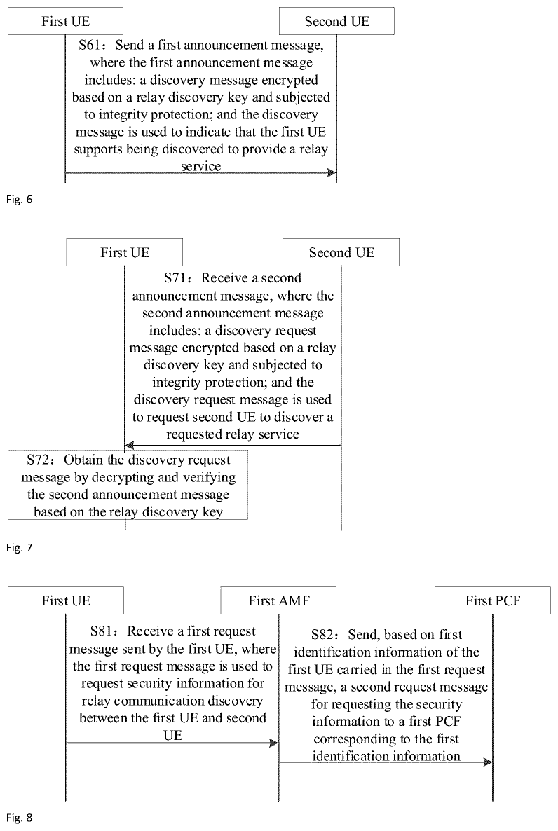

As shown in FIG. 5, an example of the disclosure provides a relay communication method, performed by first UE, and including the step S51.

Step S51: a relay discovery key is determined based on an intermediate discovery key, where
the relay discovery key includes at least one of the following:
an encryption key (Discovery User Confidentiality Key, DUCK), used to encrypt and decrypt a discovery message of relay communication; or
an integrity assurance key (Discovery User Integrity Key, DUIK), used to protect integrity of the discovery message of relay communication.

In an optional example, the relay discovery key may include a scrambling key (Discovery User Scrambling Key, DUSK), used to scramble the discovery message of relay communication.

In some examples, step S51 includes one of the following:
determining the relay discovery key based on the intermediate discovery key and an algorithm identity; or
determining the relay discovery key based on the intermediate discovery key, the algorithm identity and an RSC.

In the examples of the disclosure, the algorithm identity may include a first algorithm identity and/or a second algorithm identity in the above examples; the RSC may be the RSC in the above examples; and the intermediate discovery key may be the intermediate discovery key in the above examples.

An example of the disclosure provides a relay communication method, performed by first UE, and including: determining a relay discovery key based on an intermediate discovery key and an algorithm identity.

An example of the disclosure provides a relay communication method, performed by first UE, and including: determining a relay discovery key based on an intermediate discovery key, an algorithm identity and an RSC.

For example, the derivation of the relay discovery key may be as follows, where the RSC and the intermediate discovery key are used as input parameters:
FC=TBD
P0=0x00 if DUSK is being derived, 0x01 if DUCK is being derived, or 0x02 if DUIK is being derived;
L0=length of P0 (i.e. 0x00 0x01)
P1=algorithm identity
L1=length of algorithm identity (i.e. 0x00 0x01)
P2=Relay Service Code (RSC)
L2=length of RSC (i.e. 0x00 0x03).

Here, when P0 is 0x00, DUSK is being derived; when P0 is 0x01, DUCK is being derived; or when P0 is 0x02, DUIK is being derived.

Here, an encryption algorithm and an integrity protection algorithm may be set in any realizable manner.

Here, an input key is a 256K near-field service relay discovery key (PRDK); and the PRDK may be the intermediate discovery key in the above examples.

In this way, in the example of the disclosure, by adding the RSC to the input parameters when determining the relay discovery key, in this way, the relay discovery key bound to the specific relay service may be obtained.

It is to be noted that those skilled in the art may understand that the method provided by the examples of the disclosure may be performed separately, or performed together with some methods in the examples of the disclosure, or some methods in the related art.

As shown in FIG. 6, an example of the disclosure provides a relay communication method, performed by first UE, and including the step S61.
step S61: a first announcement message is sent, where the first announcement message includes: a discovery message encrypted based on a relay discovery key and subjected to integrity protection; and the discovery message is used to indicate that the first UE supports being discovered to provide a relay service.

Here, the discovery message included in the first announcement message may be: a discovery message encrypted based on the relay discovery key and an encryption algorithm, and subjected to integrity protection based on an integrity protection algorithm.

Sending the first announcement message in step S61 may be: broadcasting the first announcement message.

In an example, the discovery message includes at least one RSC. In this way, the first UE may notify other UE that the first UE supports relay services indicated by which RSC or RSCs. The other UE may be, but is not limited to, second UE.

In another example, the discovery message includes, but is not limited to: at least one RSC and identification information of the first UE. The identification information may be, but is not limited to, first identification information in the above examples. For example, the identification information may be any information that may uniquely identify the first UE, such as a string of characters. In this way, the first UE may inform other UE which first UE supports the relay service indicated by the RSC.

In this way, in the example of the disclosure, the first announcement message may be broadcasted by the first UE, so that the second UE and others, which monitored the first announcement message, may know the relay service that is able to be provided by the first UE. The discovery message in the first announcement message is the discovery message encrypted with the relay discovery key and subjected to integrity protection, thus the security of relay communication discovery between the first UE and the second UE can be improved.

As shown in FIG. 7, an example of the disclosure provides a relay communication method, performed by first UE, and including the step S71-step S72.

Step S71: a second announcement message is received, where the second announcement message includes: a discovery request message encrypted based on a relay discovery key and subjected to integrity protection; and the discovery request message is used to request second UE to discover a requested relay service.

Step S72: the discovery request message is obtained by decrypting and verifying the second announcement message based on the relay discovery key.

Here, the discovery request message in the second announcement message may be: a discovery request message encrypted based on the relay discovery key and an encryption algorithm, and subjected to integrity protection based on an integrity protection algorithm.

Receiving the second announcement message in step S71 may be: receiving the second announcement message sent by the second UE.

In an example, the discovery request message includes at least one RSC. In this way, the first UE may learn relay service(s) indicated by that or which RSCs the second UE needs to request.

In another example, the discovery request message includes, but is not limited to: the RSC and identification information of the second UE. In this way, the first UE may know which second UE needs to request the relay service indicated by the RSC.

Decrypting and verifying the second announcement message based on the relay discovery key in step S72 includes: decrypting the second announcement message based on the relay discovery key and a decryption algorithm corresponding to an encryption algorithm, and verifying the integrity of the second announcement message through an integrity protection algorithm.

In the example of the disclosure, the discovery request message sent by the second UE may be received by the first UE so as to learn the relay service that the second UE needs to request. The discovery request message is a message encrypted through the relay discovery key and subjected to integrity protection, thus the security of relay communication discovery between the first UE and the second UE can be improved.

An example of the disclosure provides a relay communication method, performed by first UE, and including: a third announcement message is sent, where the third announcement message includes: a discovery response message encrypted based on a relay discovery key and subjected to integrity protection, where the discovery response message is determined based on a discovery request message.

Here, the discovery response message in the third announcement message may be: a discovery response message encrypted based on the relay discovery key and an encryption algorithm, and subjected to integrity protection based on an integrity protection algorithm.

Here, if the first UE determines that a relay service provided under authorization of the first UE includes the relay service requested by the discovery request message, the discovery response message sent by the first UE may be a confirmed response message. Or, if the first UE determines that the relay service authorized by the first UE does not include the relay service requested by the discovery request message, the discovery response message is not sent by the first UE.

In the example of the disclosure, second UE may be informed whether to be able to provide the relay service requested by the second UE according to the discovery response message sent by the first UE. The discovery response message may be a message encrypted through the relay discovery key and subjected to integrity protection, thus the security of relay communication discovery between the first UE and the second UE can be improved.

Moreover, in response to determining that the announcement message, encrypted through the relay discovery key and subjected to integrity protection, sent by the second UE is received by the first UE, the integrity of the announcement message may be decrypted and verified using the same relay discovery key, and the content in the announcement message may be accurately obtained.

It is to be noted that those skilled in the art may understand that the method provided by the examples of the disclosure may be performed separately, or performed together with some methods in the examples of the disclosure, or some methods in the related art.

The following relay communication method is performed by a first AMF and is similar to the description of the above relay communication method performed by the first UE; and for the technical details not disclosed in the examples of the relay communication method performed by the first AMF, reference may be made to the description of an example of the relay communication method performed by the first UE, which will not be described in detail here.

As shown in FIG. 8, an example of the disclosure provides a relay communication method, performed by a first AMF, and including the step S81-step S82.

Step S81: a first request message sent by first UE is received, where the first request message is used to request security information for relay communication discovery between the first UE and second UE.

Step S82: based on first identification information of the first UE carried in the first request message, a second request message for requesting the security information is sent to a first PCF corresponding to the first identification information.

An example of the disclosure provides a relay communication method, performed by a first AMF, and including:
a second response message sent by a first PCF is received, where the second response message includes security information; and
based on second identification information of first UE carried in the second response message, a first response message carrying the security information is sent to first UE.

In some examples of the disclosure, a first request message and a second request message may respectively be the first request message and the second request message in step S41; the security information may be the security information in step S41 above; and the first identification information may be the first identification information in step S41.

In some examples of the disclosure, the first response message and the second response message may be the first response message and the second response message in the above examples; and the second identification information may be the second identification information in the above examples.

For example, the first identification information may include at least one of the following: an SUCI or a GUTI. The second identification information may include an SUPI.

For example, both the first request message and the second request message may include: a message related to key request. Both the first response message and the second response message may include: a message related to key response. The security information includes: an intermediate discovery key.

For example, the message related to key request includes: an RSC indicating a relay service.

For example, the message related to key request includes at least one of the following:
a type indication information, used to indicate a type of a discovery message of relay communication; or
a first security indication information, used to indicate a security capability of the first UE.

For example, the message related to key response further includes at least one of the following:
an algorithm identity, where the algorithm identity includes at least one of the following: a first algorithm identity, used to indicate an algorithm for encrypting and decrypting a discovery message of relay communication; or a second algorithm identity, used to indicate an algorithm for protecting integrity of the discovery message of relay communication; or
a time related information, used to determine whether the discovery message of relay communication is subjected to replay attack.

For example, the message related to key request includes: an RSC indicating a relay service; and
the message related to key response includes: an intermediate discovery key for the RSC, or the intermediate discovery key for the RSC and identification information of the intermediate discovery key.

In this way, in the example of the disclosure, the first AMF may send a second request message for requesting security to the first PCF after receiving the first request message for requesting the security information sent by the first UE, so as to acquire the security information needed by the first UE.

The first AMF may send the first response message including the security information to the first UE after receiving the second response message including the security information and sent by the first PCF, so that the first UE may obtain the security information. In this way, security protection may be performed through the security information, during the relay communication discovery between the first UE and the second UE, and the security of relay communication between the first UE and the second UE is improved.

An example of the disclosure provides a relay communication method, performed by a first AMF, and including: based on first identification information and a first mapping relationship, second identification information corresponding to first UE is determined, where the first mapping relationship includes a correspondence between the first identification information and the second identification information.

Here, the first mapping relationship includes a correspondence between an SUCI and an SUPI, and/or a correspondence between a GUTI and the SUPI.

It may be understood that when the first request message is sent to the first AMF by the first UE, the first request message includes the first identification information; and the first identification information may be temporary or concealed related identification information. When a second request message is sent to a first PCF by the first AMF, the second request message may be the SUPI; and the second identification information may be permanent identification information. Typically, the AMF primarily receives temporary identifiers, while the PCF receives permanent identifiers.

In this way, in the example of the disclosure, the second identification information of the first UE corresponding to the first identification information of the first UE may be accurately determined based on the first identification information of the first UE, a first mapping table stored in the first AMF and so on, so as to facilitate the subsequent transmission of security information related to the first UE by the first PCF.

An example of the disclosure provides a relay communication method, performed by a first AMF, and including:
a first RSC set sent by the first PCF is received, where the first RSC set includes: at least one first RSC; and the first RSC is an RSC of a relay service that is able to be provided by the first UE; and
the first RSC set is sent to the first UE.

In some examples of the disclosure, the first RSC set may be the first RSC set in the above examples.

In this way, in the example of the disclosure, the first RSC set sent by the first PCF may be sent to the first UE through the first AMF, so that the first UE knows a relay service that may be pre-configured and provided by the first UE.

The above implementations may be described on a first UE side, and will not be repeated here.

It is to be noted that those skilled in the art may understand that the method provided by the examples of the disclosure may be performed separately, or performed together with some methods in the examples of the disclosure, or some methods in the related art.

The following relay communication method is performed by second UE and is similar to the description of the above relay communication method performed by the first UE and/or the first AMF; and for the technical details not disclosed in the examples of the relay communication method performed by the second UE, reference may be made to the description of an example of the relay communication method performed by the first UE and/or the first AMF, which will not be described in detail here.

As shown in FIG. 9, an example of the disclosure provides a relay communication method, performed by second UE, and including the step S91.

Step S91: a third request message is sent to a second AMF, where the third request message is used to request security information for relay communication discovery between first UE and the second UE, the third request message includes third identification information of the second UE, and the third identification information is used by the second AMF to send fourth request information for requesting the security information to a second PCF corresponding to the second UE.

Here, the third identification information may be used to identify the second UE.

In an example, the third identification information includes at least one of the following: an SUCI or a GUTI.

Here, the fourth request message is used to request security information for relay communication discovery between the first UE and the second UE.

In an example, fourth identification information of the first UE is carried in the fourth request message. The fourth identification information may be used to identify the first UE.

In an example, the fourth identification information includes an SUPI corresponding to the third identification information.

Here, a second mapping relationship may be set by the second AMF; and the second mapping relationship includes a correspondence between the third identification information and the fourth identification information. For example, the second mapping relationship includes a correspondence between the SUCI and the SUPI, and/or a correspondence between the GUTI and the SUPI. In this way, the SUPI of the first UE may be determined by the second AMF based on the SUCI and/or the SUPI of the first UE. In this way, the second AMF may know which first UE send a first request message and send a second request message to the first PCF corresponding to the first UE.

An example of the disclosure provides a relay communication method, performed by second UE, and including: a third response message sent by a second AMF is received, where the third response message includes: security information included in a fourth response message, and the fourth response message is sent by the second PCF based on fourth identification information of the second UE included in the third response message.

In an example, the third request message includes: a message related to key request; the third response message includes: a message related to key response; and the security information includes: an intermediate discovery key.

Here, the fourth request message may include the message related to key request. In an example, the difference between the third request message and the fourth request message is that the third identification information is carried in the third request message; and the fourth identification information is carried in the fourth request message.

Here, the fourth response message may include the message related to key response. In an example, the difference between the third response message and the fourth response message is that the fourth identification information is carried in the fourth response message; and the third identification information is carried in the third response message or the third identification information and the fourth identification information are not carried in the third response message.

In some examples, the message related to key request includes: a relay service code (RSC) indicating a relay service; and
the message related to key response includes: an intermediate discovery key for the RSC, or the intermediate discovery key for the RSC and identification information of the intermediate discovery key.

In some examples, the message related to key request further includes at least one of the following:
a type indication information, used to indicate a type of a discovery message of relay communication; or
a second security indication information, used to indicate a security capability of the second UE.

In some examples, the message related to key response includes at least one of the following:
an algorithm identity, where the algorithm identity includes at least one of the following: a first algorithm identity, used to indicate an algorithm for encrypting and decrypting a discovery message of relay communication; or a second algorithm identity, used to indicate an algorithm for protecting integrity of the discovery message of relay communication; or
a time related information, used to determine whether the discovery message of relay communication is subjected to replay attack.

An example of the disclosure provides a relay communication method, performed by second UE, and including:
a relay discovery key is determined based on an intermediate discovery key, where the relay discovery key includes at least one of the following:
an encryption key (DUCK), used to encrypt and decrypt a discovery message of relay communication; or
an integrity assurance key (DUIK), used to protect integrity of the discovery message of relay communication.

An example of the disclosure provides a relay communication method, performed by second UE, and including:
a relay discovery key is determined based on an intermediate discovery key and an algorithm identity; or
the relay discovery key is determined based on the intermediate discovery key, the algorithm identity and an RSC.

An example of the disclosure provides a relay communication method, performed by second UE, and including:
a first announcement message is received, where the first announcement message includes: a discovery message encrypted based on a relay discovery key and subjected to integrity protection; and the discovery message is used to indicate that first UE supports being discovered to provide a relay service; and
the discovery message is obtained by decrypting and verifying the first announcement message based on the relay discovery key.

An example of the disclosure provides a relay communication method, performed by second UE, and including:
a second announcement message is sent, where the second announcement message includes: a discovery request message encrypted based on a relay discovery key and subjected to integrity protection; and the discovery request message is used to request the second UE to discover a requested relay service.

An example of the disclosure provides a relay communication method, performed by second UE, and including:
a third announcement message is received, where the third announcement message includes: a discovery response message encrypted based on a relay discovery key and subjected to integrity protection, where the discovery response message is determined based on a discovery request message; and
the discovery response message is obtained by decrypting and verifying the third announcement message based on the relay discovery key.

In some examples of the disclosure, a first announcement message, a second announcement message, and the third announcement message may be the same as the first announcement message, the second announcement message, and the third announcement message in the above examples, respectively. Moreover, in the examples of the disclosure, a manner of encrypting a discovery message based on the relay discovery key and an encryption algorithm and performing integrity protection based on an integrity protection algorithm is similar to the corresponding manner in the above examples; and a manner of decrypting the message and verifying integrity of the messages based on the relay discovery key and a decryption algorithm corresponding to the encryption algorithm is similar to the method in the above examples.

An example of the disclosure provides a relay communication method, performed by second UE, and including: a second RSC set sent by a second AMF is received, where the second RSC set includes: at least one second RSC; and the second RSC is an RSC of a relay service that is able to be obtained by the second UE.

Here, the second RSC set may be sent by a second PCF. Here, the second RSC set may also be sent by a DDNMF corresponding to the second UE.

In an example, discovery parameters carrying the second RSC set and sent by the second AMF are received by the second UE; and the discovery parameters are sent by the second PCF or the DDNMF corresponding to the second UE.

In this way, in the example of the disclosure, the second RSC set may be acquired from a core network element such as the second PCF through the second UE, and the relay service that is able to be obtained by the second UE may be learned.

The above implementations may be described specifically on a first UE side and/or a first AMF side, and will not be repeated here.

It is to be noted that those skilled in the art may understand that the method provided by the examples of the disclosure may be performed separately, or performed together with some methods in the examples of the disclosure, or some methods in the related art.

The following relay communication method is performed by a second AMF and is similar to the description of the above relay communication method performed by the first UE, the second UE and/or the first AMF; and for the technical details not disclosed in the examples of the relay communication method performed by the second AMF, reference may be made to the description of an example of the relay communication method performed by the first UE, the second UE and/or the first AMF, which will not be described in detail here.

As shown in FIG. 10, an example of the disclosure provides a relay communication method, performed by a second AMF, and including the step S101-step S102.

Step S101: a third request message sent by second UE is received, where the third request message is used to request security information for relay communication discovery between first UE and the second UE.

Step S102: based on third identification information of the second UE carried in the third request message, a fourth request message for requesting the security information is sent to a second PCF corresponding to the third identification information.

An example of the disclosure provides a relay communication method, performed by a second AMF, and including: a fourth response message sent by a second PCF is received, where the fourth response message includes security information; and
based on fourth identification information of the second UE carried in the fourth response message, a third response message carrying the security information is sent to the second UE.

In some examples of the disclosure, a third request message and a fourth request message may respectively be the third request message and the fourth request message in step S91; the security information may be the security information in the examples above; third identification information and the fourth identification information may be the third identification information and the fourth identification information in the examples above; and a third response message and the fourth response message may be the third response message and the fourth response message in the examples above.

For example, the third identification information may include at least one of the following: an SUCI or a GUTI. The fourth identification information may include an SUPI.

For example, both the third request message and the fourth request message may include: a message related to key request. Both the third response message and the fourth response message may include: a message related to key response. The security information includes: an intermediate discovery key.

For example, the message related to key request includes: an RSC indicating a relay service.

For example, the message related to key request includes at least one of the following:
a type indication information, used to indicate a type of a discovery message of relay communication; or
a second security indication information, used to indicate a security capability of the second UE.

For example, the message related to key response further includes at least one of the following:
an algorithm identity, where the algorithm identity includes at least one of the following: first algorithm identity, used to indicate an algorithm for encrypting and decrypting a discovery message of relay communication; or a second algorithm identity, used to indicate an algorithm for protecting integrity of the discovery message of relay communication; or
a time related information, used to determine whether the discovery message of relay communication is subjected to replay attack.

For example, the message related to key request includes: the RSC indicating the relay service; and
the message related to key response includes: an intermediate discovery key for the RSC, or the intermediate discovery key for the RSC and identification information of the intermediate discovery key.

An example of the disclosure provides a relay communication method, performed by a second AMF, and including: based on third identification information and a second mapping relationship, fourth identification information corresponding to second UE is determined, where the second mapping relationship includes a correspondence between the third identification information and the fourth identification information.

Here, the second mapping relationship includes a correspondence between an SUCI and an SUPI, and/or a correspondence between a GUTI and the SUPI.

An example of the disclosure provides a relay communication method, performed by a second AMF, and including:
a second RSC set sent by a second PCF is received, where the second RSC set includes: at least one second RSC; and the second RSC is an RSC of a relay service that is able to be obtained by second UE; and
the second RSC set is sent to the second UE.

In some examples of the disclosure, the second RSC set may be the second RSC set in the above examples.

In this way, in the example of the disclosure, the second RSC set sent by the second PCF may be sent to the second UE through the second AMF, so that the second UE knows a relay service that is able to be obtained.

The above implementations may be described specifically on a first UE side, a second UE side and/or a first AMF side, and will not be repeated here.

It is to be noted that those skilled in the art may understand that the method provided by the examples of the disclosure may be performed separately, or performed together with some methods in the examples of the disclosure, or some methods in the related art.

The following relay communication method is performed by a first PCF and is similar to the description of the above relay communication method performed by the first UE, the second UE, the first AMF and/or the second AMF; and for the technical details not disclosed in the examples of the relay communication method performed by the first PCF, reference may be made to the description of an example of the relay communication method performed by the first UE, the second UE, the first AMF and/or the second AMF, which will not be described in detail here.

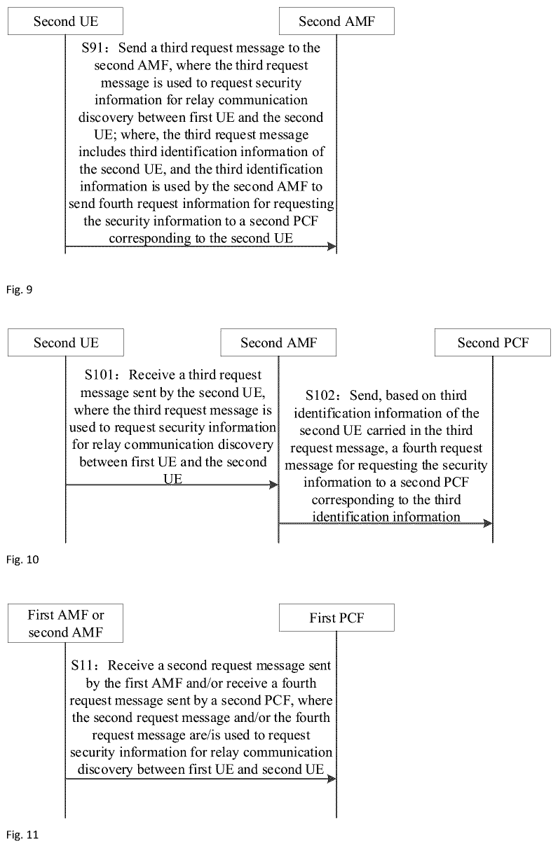

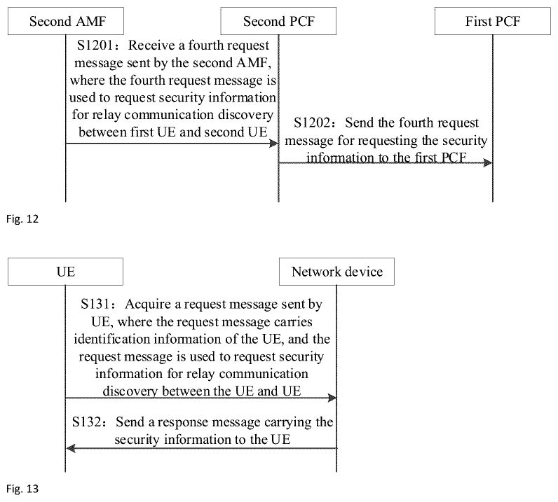

As shown in FIG. 11, an example of the disclosure provides a relay communication method, performed by a first PCF, and including the step S11.

Step S11: a second request message sent by a first AMF is received and/or a fourth request message sent by a second PCF is received, where the second request message and/or the fourth request message are/is used to request security information for relay communication discovery between first UE and second UE.

In some examples of the disclosure, a first request message, the second request message, a third request message, and the fourth request message are respectively the first request message, the second request message, the third request message, and the fourth request message in the above examples; a first response message, a second response message, a third response message, and a fourth response message are respectively the first response message, the second response message, the third response message, and the fourth response message in the above examples; first identification information, second identification information, third identification information, and fourth identification information are respectively the first identification information, the second identification information, the third identification information, and the fourth identification information in the above examples; and security information is the security information in the above examples.

For example, the second request message and/or the fourth request message include/includes: a message related to key request; the second response message and/or the fourth response message include/includes: a message related to key response; and the security information includes: an intermediate discovery key.

For example, the message related to key request includes: an RSC indicating a relay service.

For example, the message related to key request includes at least one of the following:
a type indication information, used to indicate a type of a discovery message of relay communication;
a first security indication information, used to indicate a security capability of the second UE; or
a second security indication information, used to indicate the security capability of the second UE.

For example, the message related to key response further includes at least one of the following:
an algorithm identity, where the algorithm identity includes at least one of the following: a first algorithm identity, used to indicate an algorithm for encrypting and decrypting a discovery message of relay communication; or a second algorithm identity, used to indicate an algorithm for protecting integrity of the discovery message of relay communication; or
a time related information, used to determine whether the discovery message of relay communication is subjected to replay attack.

For example, the message related to key request includes: the RSC indicating the relay service; and
the message related to key response includes: an intermediate discovery key for the RSC, or the intermediate discovery key for the RSC and identification information of the intermediate discovery key.

An example of the disclosure provides a relay communication method, performed by a first PCF, and including: security information is determined based on a second request message; and/or, the security information is determined based on a fourth request message.

An example of the disclosure provides a relay communication method, performed by a first PCF, and including: an intermediate discovery key is determined based on a relay service indicated by a received RSC.

For example, the first PCF receives a message related to key request and determines an intermediate discovery message of the relay service indicated by the RSC based on the RSC carried in the message related to key request. In this way, the first PCF in the example of the disclosure may generate the intermediate discovery key corresponding to the RSC through the received RSC.

For example, a correspondence between at least one RSC and the intermediate discovery key may be saved by the first PCF; and the intermediate discovery key of the received RSC may be determined by the first PCF based on the correspondence between the received RSC and the intermediate discovery key. Thus, the intermediate discovery key corresponding to the received RSC may be determined by the first PCF in the example of the disclosure based on the correspondence between a locally stored RSC and the intermediate discovery key as well as the received RSC. In this way, the obtained intermediate discovery key corresponding to the RSC may be saved by the first PCF, so that the intermediate discovery key of the RSC may be determined subsequently based on the saved information, thus power consumption generated by generating the intermediate discovery key may be reduced.

An example of the disclosure provides a relay communication method, performed by a first PCF, and including: an encryption algorithm and/or an integrity algorithm are/is determined based on first security indication information; and/or, the encryption algorithm and/or the integrity algorithm are/is determined based on second security indication information.

In this way, in the example of the disclosure, the suitable encryption algorithms and/or integrity protection algorithms for first UE and/or second UE may be determined based on a security capability of the first UE and/or the second UE.

In other examples, any achievable encryption algorithm and/or integrity protection algorithm may also be determined by the first PCF. A first algorithm identity indicating the encryption algorithm and/or a second algorithm identity corresponding to and indicating the integrity protection algorithm are/is sent to a first AMF and/or the second PCF by the first PCF, so that the first UE and the second UE may obtain the first algorithm identity and the second algorithm identity; and it is merely necessary to meet that the first algorithm identity and/or the second algorithm identity obtained by the first UE and the second UE are/is consistent. Which encryption algorithm and/or the integrity protection algorithm is determined by the first PCF is not limited.

In some examples, a second request message includes second identification information of the first UE.

The method includes: a second response message is sent to the first AMF, where the second response message includes the second identification information and the second response message of the security information.

An example of the disclosure provides a relay communication method, performed by a first PCF, and including: a second response message is sent to a first AMF, where the second response message includes second identification information and a second response message of security information.

In some examples, sending the second response message to the first AMF includes: the second response message is sent to the first AMF in response to determining, based on a received RSC, that first UE is a relay service indicated by an authorized service RSC.

An example of the disclosure provides a relay communication method, performed by a first PCF, and including: a second response message is sent to a first AMF in response to determining, based on a received RSC, that first UE is a relay service indicated by an authorized service RSC.

In some examples, a fourth request message includes fourth identification information of second UE.

The method includes: a fourth response message is sent to a second PCF, where the fourth response message includes the fourth identification information and a fourth response message of security information.

An example of the disclosure provides a relay communication method, performed by a first PCF, and including: a fourth response message is sent to a second PCF, where the fourth response message includes fourth identification information and a fourth response message of security information.

In some examples, sending the fourth response message carried to the second PCF includes:
a message related to key response is sent to the second PCF in response to determining that first UE is authorized to provide a relay service to second UE.

An example of the disclosure provides a relay communication method, performed by a first PCF, and including: a message related to key response is sent to a second PCF in response to determining that first UE is authorized to provide a relay service to second UE.

An example of the disclosure provides a relay communication method, performed by a first PCF, and including: a first RSC set is sent to a first AMF, where the first RSC set includes: at least one first RSC; and the first RSC is an RSC of a relay service that is able to be provided by first UE.

The above implementations may be described specifically on a first UE side, a second UE side, a first AMF side and/or a second AMF side, and will not be repeated here.

It is to be noted that those skilled in the art may understand that the method provided by the examples of the disclosure may be performed separately, or performed together with some methods in the examples of the disclosure, or some methods in the related art.

The following relay communication method is performed by a second PCF and is similar to the description of the above relay communication method performed by the first UE, the second UE, the first AMF, the second AMF and/or the first PCF; and for the technical details not disclosed in the examples of the relay communication method performed by the second PCF, reference may be made to the description of an example of the relay communication method performed by the first UE, the second UE, the first AMF, the second AMF and/or the first PCF, which will not be described in detail here.

As shown in FIG. 12, an example of the disclosure provides a relay communication method, performed by a second PCF, and including the step S1201-step S1202.

Step S1201: a fourth request message sent by a second AMF is received, where the fourth request message is used to request security information for relay communication discovery between first UE and second UE.

Step S1202: the fourth request message for requesting security information is sent to a first PCF.

In some examples, the fourth request message includes fourth identification information of the second UE.

The method includes: a fourth response message is sent to the first AMF, where the fourth response message includes the fourth identification information and the security information.

An example of the disclosure provides a relay communication method, performed by a second PCF, and including: a fourth response message is sent to a first AMF, where the fourth response message includes fourth identification information and security information.

In some examples of the disclosure, a third request message and the fourth request message are respectively the third request message and the fourth request message in the above examples; a third response message and a fourth response message are respectively the third response message and the fourth response message in the above examples; third identification information and the fourth identification information are respectively the third identification information and the fourth identification information in the above examples; and the security information is the security information in the above examples.

For example, the fourth request message includes: a message related to key request; the fourth response message includes: a message related to key response; and the security information includes: an intermediate discovery key.

For example, the message related to key request includes: an RSC indicating a relay service; and
the message related to key response includes: an intermediate discovery key for the RSC, or an intermediate information key for the RSC and identification information of the intermediate information key.

In some examples, the step S1202 includes:
in response to determining to authorize the second UE to discover a relay service, the fourth request message for requesting the security information is sent to a first PCF.

An example of the disclosure provides a relay communication method, performed by a second PCF, and including: in response to determining to authorize second UE to discover a relay service, a fourth request message for requesting security information is sent to a first PCF.

Here, the second PCF is configured with a mapping table between an RSC and an address of a PCF of a potential U2N relay that provides a relay service indicated by the RSC. In this way, the first PCF that needs to send the fourth request message may be determined by the second PCF based on an RSC included in a third request message.

An example of the disclosure provides a relay communication method, performed by a second PCF, and including: a second RSC set is sent to a second AMF, where the second RSC set includes: at least one second RSC; and the second RSC is an RSC of a relay service that is able to be obtained by second UE.

The above implementations may be described specifically on a first UE side, a second UE side, a first AMF side, a second AMF side and/or a first PCF side, and will not be repeated here.

It is to be noted that those skilled in the art may understand that the method provided by the examples of the disclosure may be performed separately, or performed together with some methods in the examples of the disclosure, or some methods in the related art.

The following relay communication method is performed by a network device and is similar to the description of the above relay communication method performed by the first UE, the second UE, the first AMF, the second AMF, the first PCF and/or the second PCF; and for the technical details not disclosed in the examples of the relay communication method performed by the network device, reference may be made to the description of an example of the relay communication method performed by the first UE, the second UE, the first AMF, the second AMF, the first PCF and/or the network device, which will not be described in detail here.

As shown in FIG. 13, an example of the disclosure provides a relay communication method, performed by a network device, and including the step S131-step S132.

Step S131: a request message sent by UE is acquired, where the request message carries identification information of the UE, and the request message is used to request security information for relay communication discovery between the UE and UE.

Step S132: a response message carrying the security information is sent to the UE.

In some examples of the disclosure, the UE may be the first UE and/or the second UE in the above examples; in response to determining that the UE is the first UE, the identification information of the UE may be the first identification information and/or the second identification information in the above examples; and in response to determining that the UE is the second UE, the identification information of the UE may be the third identification information and/or the fourth identification information in the above examples. In response to determining that the UE is the first UE, the request message may be the first request message and/or the second request message in the above examples; and in response to determining that the UE is the second UE, the request message may be the third request message and/or the fourth request message in the above examples. In response to determining that the UE is the first UE, the response message may be the first response message and/or the second response message in the above examples; and in response to determining that the UE is the second UE, the response message may be the third response message and/or the fourth response message in the above examples. In some examples of the disclosure, the security information may be the security information in the above examples.

In some examples, the UE includes: first UE; and the network device includes: a first AMF and a first PCF;
step S131 includes: a first request message sent by the first UE is acquired by the first AMF; and based on first identification information carried in the first request message, a second request message carrying second identification information is sent to the first PCF, where the first request message and/or the second request message are/is used to request the security information for relay communication discovery between the first UE and second UE; and
step S132 includes: a second response message sent by the first PCF is acquired by the first AMF, and based on second identification information of the second response message, the first response message is sent to the first UE, where the first response message and/or the second response message carry/carries the security information.

An example of the disclosure provides a relay communication method, performed by a network device, the network device includes a first AMF and a first PCF, and the method includes:
a first request message sent by first UE is acquired by the first AMF; and based on first identification information carried in the first request message, a second request message carrying second identification information is sent to the first PCF, where the first request message and/or the second request message are/is used to request security information for relay communication discovery between the first UE and second UE; and
a second response message sent by the first PCF is acquired by the first AMF, and based on second identification information of the second response message, the first response message is sent to the first UE, where the first response message and/or the second response message carry/carries the security information.

In some examples, the first request message and/or the second request message include/includes: a relay service code (RSC) indicating a relay service; and
the first response message and/or the second response message include/includes: an intermediate discovery key for the RSC, or the intermediate discovery key for the RSC and identification information of the intermediate discovery key.

In some examples, the UE includes the second UE; and the network device includes: a second AMF, the first PCF and a second PCF;
step S131 includes:
a third request message sent by the second UE is acquired by the second AMF; and based on third identification information carried in the third request message, a fourth request message carrying fourth identification information is sent to the second PCF, where the third request message and/or the fourth request message are/is used to request the security information for relay communication discovery between the first UE and the second UE; and
the fourth request message is sent to the first PCF by the second PCF; and
step S132 includes:
a fourth response message is sent to the second PCF by the first PCF; and
the fourth response message sent by the second PCF is acquired by the second AMF, and based on fourth identification information of the fourth response message, a third response message is sent to the second UE, where the third response message and/or the fourth response message carry/carries the security information.

An example of the disclosure provides a relay communication method, performed by a network device, the network device includes a second AMF, a first PCF and a second PCF, and the method includes:
a third request message sent by second UE is acquired by the second AMF; and based on third identification information carried in the third request message, a fourth request message carrying fourth identification information is sent to the second PCF, where the third request message and/or the fourth request message are/is used to request security information for relay communication discovery between first UE and the second UE;
the fourth request message is sent to the first PCF by the second PCF;
a fourth response message is sent to the second PCF by the first PCF; and
the fourth response message sent by the second PCF is acquired by the second AMF, and based on fourth identification information of the fourth response message, a third response message is sent to the second UE, where the third response message and/or the fourth response message carry/carries the security information.

In some examples, sending, by the second PCF, the fourth request message to the first PCF includes:
it is determined by the second PCF to authorize the second UE to discover a relay service and send the fourth request message to the first PCF; and
sending, by the first PCF, the fourth response message to the second PCF includes:
it is determined by the first PCF to authorize the first UE to provide the relay service to the second UE, and send the fourth response message to the second PCF.

An example of the disclosure provides a relay communication method, performed by a network device, the network device includes a first PCF and a second PCF, and the method includes:
it is determined by the second PCF to authorize second UE to discover a relay service and send a fourth request message to the first PCF; and
it is determined by the first PCF to authorize first UE to provide the relay service to second UE, and send a fourth response message to the second PCF.

In some examples, the third request message and/or the fourth request message include/includes: an RSC indicating the relay service; and
the third response message and/or the fourth response message include/includes: an intermediate discovery key for the RSC, or the intermediate discovery key for the RSC and identification information of the intermediate discovery key.

The above implementations may be described specifically on a first UE side, a second UE side, a first AMF side, a second AMF side and/or a first PCF side, and will not be repeated here.

It is to be noted that those skilled in the art may understand that the method provided by the examples of the disclosure may be performed separately, or performed together with some methods in the examples of the disclosure, or some methods in the related art.

To further explain any example of the disclosure, several specific examples are provided below.

### EXAMPLE 1

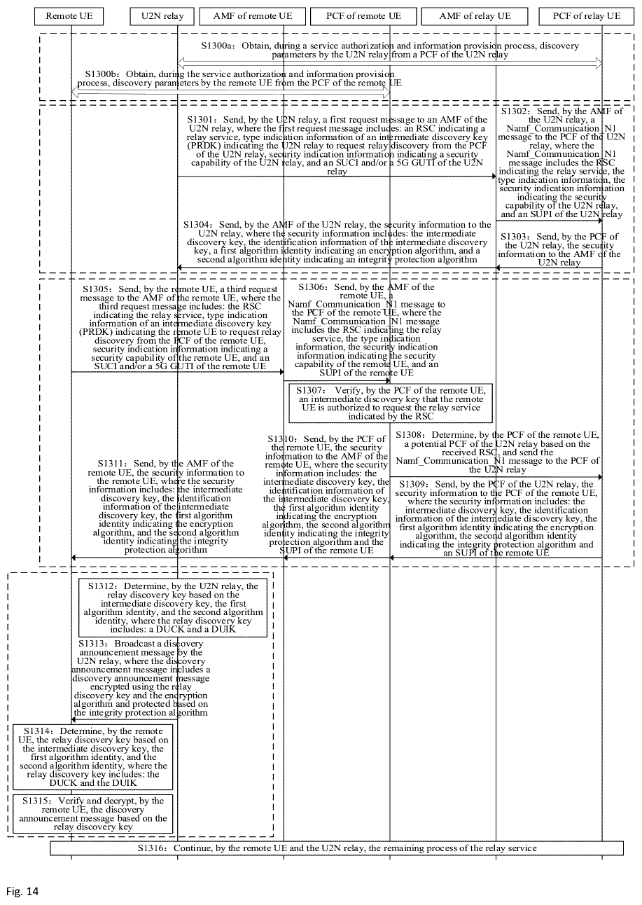

As shown in FIG. 14, an example of the disclosure provides a relay communication method, performed by a communication device, and the communication device includes: first UE, second UE, a first AMF, a second AMF, a first PCF, and a second PCF. Here, the first UE is a U2N relay, the second UE is a remote UE, the first AMF is an AMF of the U2N relay, the second AMF is an AMF of the remote UE, the first PCF is a PCF of the U2N relay, and the second PCF is a PCF of the remote UE. The relay communication method includes Step S1300a-Step S1316.
here, the PCF of the remote UE is configured with a mapping table between an RSC and an address of a PCF of a potential U2N relay that provides a relay service indicated by the RSC.

Step S1300a: during a service authorization and information provision process, discovery parameters are obtained by the U2N relay from the PCF of the U2N relay;
in step S1300a, the discovery parameters include at least one RSC; and in step S1300a, the discovery parameters may include a first RSC set in the above examples.

Step S1300b: during the service authorization and information provision process, discovery parameters are obtained by the remote UE from the PCF of the remote UE;
in step S1300b, the discovery parameters include at least one RSC; and in step S1300b, the discovery parameters may include a second RSC set in the above examples.

Step S1301: a first request message is sent to the AMF of the U2N relay by the U2N relay, and the first request message includes: an RSC indicating a relay service, type indication information of an intermediate discovery key (PRDK) indicating the U2N relay to request relay discovery from the PCF of the U2N relay, security indication information indicating a security capability of the U2N relay, and an SUCI and/or a 5G GUTI of the U2N relay;
here, the first request message is used to request the intermediate discovery key for relay communication discovery between the remote UE and the U2N relay.

Step S1302: a Namf_Communication_N1 message is sent to the PCF of the U2N relay by the AMF of the U2N relay, and the Namf_Communication_N1 message includes the RSC indicating the relay service, the type indication information, the security indication information indicating the security capability of the U2N relay, and an SUPI of the U2N relay;
here, the Namf_Communication_N1 message in step S1302 may be the second request message in the above examples; and the Namf_Communication_N1 message is used to request the intermediate discovery key for relay communication discovery between the remote UE and the U2N relay.

In an optional example, before step S1302, the method includes: the SUPI of the U2N relay is determined by the AMF of the U2N relay based on the SUCI and/or the 5G GUTI of the U2N relay and a first mapping relationship, where, the first mapping relationship includes a predefined correspondence between the SUCI and the SUPI, and/or a predefined correspondence between the GUTI and the SUPI.

Step S1303: the security information is sent to the AMF of the U2N relay by the PCF of the U2N relay;
where, the security information includes: the intermediate discovery key, identification information of the intermediate discovery key, a first algorithm identity indicating an encryption algorithm, a second algorithm identity indicating an integrity protection algorithm, and the SUPI of the U2N relay.

Here, sending the security information in step S1303 may be: sending a second response message carrying the security information.

In an optional example, before step S1303, the method includes: it is verified based on the received RSC that the U2N relay is the relay service indicated by an authorized service RSC.

In an optional example, the security information includes time related information, where the time related information includes at least one of a current time, maximum offset, and a validity timer.

In an optional example, the intermediate discovery key (PRDK) and identification information (ID) of the intermediate discovery key are generated by the PCF of U2N relay based on the RSC; and the encryption algorithm and the integrity protection algorithm which are used to protect the discovery message broadcasted between the remote UE and the U2N relay are determined by the PCF of U2N relay based on the security capability of the U2N relay.

Step S1304: the security information is sent to the U2N relay by the AMF of the U2N relay; and the security information includes: the intermediate discovery key, the identification information of the intermediate discovery key, the first algorithm identity indicating the encryption algorithm, and the second algorithm identity indicating the integrity protection algorithm;
here, sending the security information in step S1304 may be: sending a first response message carrying the security information.

In an optional example, before step S1304, the security information may be sent to which U2N relay by the AMF of the U2N relay based on the SUPI of the U2N relay.

Step S1305: a third request message is sent to the AMF of the remote UE by the remote UE, and the third request message includes: the RSC indicating the relay service, type indication information of an intermediate discovery key (PRDK) indicating the remote UE to request relay discovery from the PCF of the remote UE, security indication information indicating a security capability of the remote UE, and an SUCI and/or a 5G GUTI of the remote UE;
here, the third request message is used to request the intermediate discovery key for relay communication discovery between the remote UE and the U2N relay.

Step S1306: a Namf_Communication_N1 message is sent to the PCF of the remote UE by the AMF of the remote UE, and the Namf_Communication_N1 message includes the RSC indicating the relay service, the type indication information, the security indication information indicating the security capability of the remote UE, and an SUPI of the remote UE;
here, the Namf_Communication_N1 message in step S1306 may be the fourth request message in the above examples; and the Namf_Communication_N1 message is used to request the intermediate discovery key for relay communication discovery between the remote UE and the U2N relay.

In an optional example, before step S1306, the method includes: the SUPI of the remote UE is determined by the AMF of the remote UE based on the SUCI and/or the 5G GUTI of the remote UE and a second mapping relationship, where, the second mapping relationship includes a predefined correspondence between the SUCI and the SUPI, and/or a predefined correspondence between the GUTI and the SUPI.

Step S1307: an intermediate discovery key that the remote UE is authorized to request the relay service indicated by the RSC is verified by the PCF of the remote UE;
step S1308: a potential PCF of the U2N relay is determined by the PCF of the remote UE based on the received RSC, and the Namf_Communication_N1 message is sent to the PCF of the U2N relay;
where the Namf_Communication_N1 message includes the RSC indicating the relay service, the type indication information, the security indication information indicating the security capability of the U2N relay, and the SUPI of the U2N relay.

Step S1309: the security information is sent to the PCF of the remote UE by the PCF of the U2N relay, where the security information includes: the intermediate discovery key, the identification information of the intermediate discovery key, the first algorithm identity indicating the encryption algorithm, the second algorithm identity indicating the integrity protection algorithm and an SUPI of the remote UE.

Here, sending the security information in step S1309 may be: sending a fourth response message carrying the security information.

In an optional example, before step S1309, the method includes: it is determined by the PCF of U2N relay to authorize that the relay service indicated by the received RSC may be served by the PCF of U2N relay.

In an optional example, the intermediate discovery key (PRDK) and identification information (ID) of the intermediate discovery key are generated by the PCF of U2N relay based on the RSC; and the encryption algorithm and the integrity protection algorithm which are used to protect the discovery message broadcasted between the remote UE and the U2N relay are determined by the PCF of U2N relay based on the security capability of the U2N relay.

Here, the security information obtained in step S1309 may also be directly obtained based on the security information obtained in step S1304.

In an optional example, the security information includes the time related information, where the time related information includes at least one of the current time, the maximum offset, or the validity timer.

Step S1310: the security information is sent to the AMF of the remote UE by the PCF of the remote UE, where the security information includes: the intermediate discovery key, the identification information of the intermediate discovery key, the first algorithm identity indicating the encryption algorithm, the second algorithm identity indicating the integrity protection algorithm and the SUPI of the remote UE.

Here, sending the security information in step S1310 may be: sending the fourth response message carrying the security information.

Step S1311: the security information is sent to the remote UE by the AMF of the remote UE, where the security information includes: the intermediate discovery key, the identification information of the intermediate discovery key, the first algorithm identity indicating the encryption algorithm, and the second algorithm identity indicating the integrity protection algorithm;
here, sending the security information in step S1311 may be: sending a third response message carrying the security information.

Step S1312: the relay discovery key is determined by the U2N relay based on the intermediate discovery key, the first algorithm identity, and the second algorithm identity; and the relay discovery key includes: a DUCK and a DUIK; and

In an optional example, the relay discovery key includes a DUSK.

Step S1313: a discovery announcement message is broadcasted by the U2N relay, where the discovery announcement message includes a discovery announcement message encrypted using the relay discovery key and the encryption algorithm and protected based on the integrity protection algorithm; and
the discovery announcement message in step S1213 may be the first announcement message in the above examples.

Step S1314: the relay discovery key is determined by the remote UE based on the intermediate discovery key, the first algorithm identity, and the second algorithm identity; and the relay discovery key includes: the DUCK and the DUIK;
step S1315: the discovery announcement message is verified and decrypted by the remote UE based on the relay discovery key;
here, the discovery announcement message is verified and decrypted by the remote UE based on the relay discovery key in step S1315 to obtain the discovery message.

Step S1316: the remote UE and the U2N relay continue the remaining process of the relay service.

### EXAMPLE 2

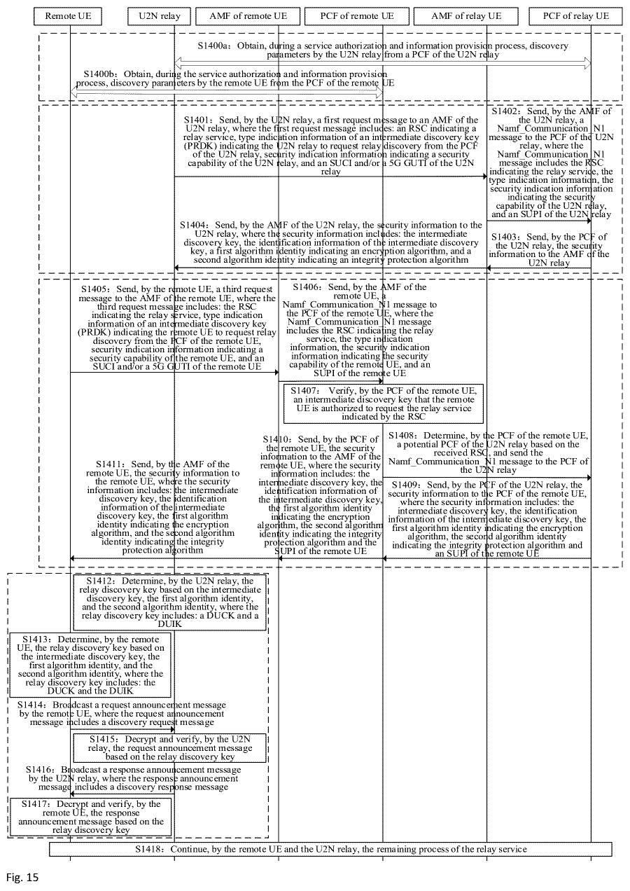

As shown in FIG. 15, an example of the disclosure provides a relay communication method, performed by a communication device, and the communication device includes: first UE, second UE, a first AMF, a second AMF, a first PCF, and a second PCF. Here, the first UE is a U2N relay, the second UE is a remote UE, the first AMF is an AMF of the U2N relay, the second AMF is an AMF of the remote UE, the first PCF is a PCF of the U2N relay, and the second PCF is a PCF of the remote UE. The relay communication method includes Step 1400a-Step 1418.
here, the PCF of the remote UE is configured with a mapping table between an RSC and an address of a PCF of a potential U2N relay that provides a relay service indicated by the RSC.

Step 1400a to step S1411 are the same as step 1300a to step S1311 in the above examples;

Step S1412: a relay discovery key is determined by the U2N relay based on an intermediate discovery key, a first algorithm identity, and a second algorithm identity; and the relay discovery key includes: a DUCK and a DUIK; and
in an optional example, the relay discovery key may include a DUSK.

Step S1413: the relay discovery key is determined by the remote UE based on the intermediate discovery key, the first algorithm identity, and the second algorithm identity; and the relay discovery key includes: the DUCK and the DUIK;

Step S1414: a request announcement message is broadcasted by the remote UE, and the request announcement message includes a discovery request message; and
the request announcement message in step S1414 is the second announcement message in the above examples. Here, the discovery request message in the request announcement message is encrypted using the relay discovery key and an encryption algorithm, and protected based on an integrity protection algorithm.

Step S1415: the request announcement message is decrypted and verified by the U2N relay based on the relay discovery key;
step S1416: a response announcement message is broadcasted by the U2N relay, and the response announcement message includes a discovery response message; and
the response announcement message in step S1416 is the third announcement message in the above examples. Here, the discovery response message in the response announcement message is encrypted using the relay discovery key and the encryption algorithm, and protected based on the integrity protection algorithm.

Step S1417: the response announcement message is decrypted and verified by the remote UE based on the relay discovery key; and
step S1418: the remote UE and the U2N relay continue the remaining process of the relay service.

It is to be noted that those skilled in the art may understand that the method provided by the examples of the disclosure may be performed separately, or performed together with some methods in the examples of the disclosure, or some methods in the related art.

As shown in FIG. 16, an example of the disclosure provides a relay communication apparatus, performed by first UE, and including:
a first sending module 21, configured to send a first request message to a first AMF, where the first request message is used to request security information for relay communication discovery between the first UE and second UE;
where, the first request message includes first identification information of the first UE, and the first identification information is used by the first AMF to send second request information for requesting the security information to a first PCF corresponding to the first UE.

An example of the disclosure provides a relay communication apparatus, performed by first UE, and including: a first receiving module, configured to receive a first response message sent by the first AMF, where the first response message includes: security information included in a second response message, and the second response message is sent by a first PCF based on second identification information of the first UE included in the second response message.

In some examples, the first identification information includes at least one of the following: an SUCI or a GUTI;
and/or,
the second identification information includes an SUPI corresponding to the first identification information.

In some examples, the first request message includes: a message related to key request; the first response message includes: a message related to key response; and the security information includes: an intermediate discovery key.

In some examples, the message related to key request includes: an indicating RSC; and
the message related to key response includes: an intermediate discovery key for the RSC, or the intermediate discovery key for the RSC and identification information of the intermediate discovery key.

In some examples, the message related to key request further includes at least one of the following:
a type indication information, used to indicate a type of a discovery message of relay communication; or
a first security indication information, used to indicate a security capability of the first UE.

In some examples, the message related to key response further includes at least one of the following:
an algorithm identity, where the algorithm identity includes at least one of the following: a first algorithm identity, used to indicate an algorithm for encrypting and decrypting a discovery message of relay communication; or a second algorithm identity, used to indicate an algorithm for protecting integrity of the discovery message of relay communication; or
a time related information, used to determine whether the discovery message of relay communication is subjected to replay attack.

An example of the disclosure provides a relay communication apparatus, performed by first UE, and including a first processing module, configured to determine a relay discovery key based on an intermediate discovery key, where the relay discovery key includes at least one of the following:
an encryption key (DUCK), used to encrypt and decrypt a discovery message of relay communication; or
an integrity assurance key (DUIK), used to protect integrity of the discovery message of relay communication.

An example of the disclosure provides a relay communication apparatus, performed by first UE, and including:
a first processing module, configured to determine a relay discovery key based on an intermediate discovery key and an algorithm identity; or
a first processing module, configured to determine the relay discovery key based on the intermediate discovery key, the algorithm identity and an RSC.

An example of the disclosure provides a relay communication apparatus, performed by first UE, and including: a first sending module 21, configured to send a first announcement message, where the first announcement message includes: a discovery message encrypted based on a relay discovery key and subjected to integrity protection; and the discovery message is used to indicate that the first UE supports being discovered to provide a relay service.

An example of the disclosure provides a relay communication apparatus, performed by first UE, and including:
a first receiving module, configured to receive a second announcement message, where the second announcement message includes: a discovery request message encrypted based on a relay discovery key and subjected to integrity protection; and the discovery request message is used to request second UE to discover a requested relay service; and
a first processing module, configured to obtain the discovery request message by decrypting and verifying the second announcement message based on the relay discovery key.

An example of the disclosure provides a relay communication apparatus, performed by first UE, and including: a first sending module 21, configured to send a third announcement message, where the third announcement message includes: a discovery response message encrypted based on a relay discovery key and subjected to integrity protection, where the discovery response message is determined based on a discovery request message.

An example of the disclosure provides a relay communication apparatus, performed by first UE, and including: a first receiving module, configured to receive a first RSC set sent by a first AMF, where the first RSC set includes: at least one first RSC; and the first RSC is an RSC of a relay service that is able to be provided by the first UE.

As shown in FIG. 17, an example of the disclosure provides a relay communication apparatus, performed by a first AMF, and including:
a second receiving module 31, configured to receive a first request message sent by first user equipment (UE), where the first request message is used to request security information for relay communication discovery between the first UE and second UE; and
a second sending module 32, configured to send, based on first identification information of the first UE carried in the first request message, a second request message for requesting the security information to a first policy control function (PCF) corresponding to the first identification information.

An example of the disclosure provides a relay communication apparatus, performed by a first AMF, and including:
a second receiving module 31, configured to receive a second response message sent by a first PCF, where the second response message includes security information; and
a second sending module 32, configured to send, based on second identification information of first UE carried in the second response message, a first response message carrying the security information to the first UE.

An example of the disclosure provides a relay communication apparatus, performed by a first AMF, and including: a second processing module, configured to determine, based on first identification information and a first mapping relationship, second identification information corresponding to first UE, where the first mapping relationship includes a correspondence between the first identification information and the second identification information.

In some examples, the first identification information includes at least one of the following: an SUCI or a GUTI; and
the second identification information includes a subscription permanent identifier (SUPI).

In some examples, the second request message includes: a message related to key request; the second response message includes: a message related to key response; and the security information includes: an intermediate discovery key.

In some examples, the message related to key request includes: a relay service code (RSC) indicating a relay service; and
the message related to key response includes: an intermediate discovery key for the RSC, or the intermediate discovery key for the RSC and identification information of the intermediate discovery key.

An example of the disclosure provides a relay communication apparatus, performed by a first AMF, and including:
a second receiving module 31, configured to receive a first RSC set sent by a first PCF, where the first RSC set includes: at least one first RSC; and the first RSC is an RSC of a relay service that is able to be provided by first UE; and
a second sending module 32, configured to send the first RSC set to the first UE.

As shown in FIG. 18, an example of the disclosure provides a relay communication apparatus, performed by second UE, and including:
a third sending module 41, configured to send a third request message to a second AMF, where the third request message is used to request security information for relay communication discovery between first UE and the second UE;
where, the third request message includes third identification information of the second UE, and the third identification information is used by the second AMF to send fourth request information for requesting the security information to a second PCF corresponding to the second UE.

An example of the disclosure provides a relay communication apparatus, performed by second UE, and including: a third receiving module, configured to receive a third response message sent by a second AMF, where the third response message includes: security information included in a fourth response message, and the fourth response message is sent by a second PCF based on fourth identification information of the second UE included in the third response message.

In some examples, the third identification information includes at least one of the following: an SUCI or a GUTI;
and/or,
the fourth identification information includes an SUPI corresponding to the third identification information.

In some examples, the third request message includes: a message related to key request; the third response message includes: a message related to key response; and the security information includes: an intermediate discovery key.

In some examples, the message related to key request includes: a relay service code (RSC) indicating a relay service; and
the message related to key response includes: an intermediate discovery key for the RSC, or the intermediate discovery key for the RSC and identification information of the intermediate discovery key.

In some examples, the message related to key request further includes at least one of the following:
a type indication information, used to indicate a type of a discovery message of relay communication; or
a second security indication information, used to indicate the security capability of the second UE.

In some examples, the message related to key response includes at least one of the following:
an algorithm identity, where the algorithm identity includes at least one of the following: a first algorithm identity, used to indicate an algorithm for encrypting and decrypting a discovery message of relay communication; or a second algorithm identity, used to indicate an algorithm for protecting integrity of the discovery message of relay communication; or
a time related information, used to determine whether the discovery message of relay communication is subjected to replay attack.

An example of the disclosure provides a relay communication apparatus, performed by second UE, and including a third processing module, configured to determine a relay discovery key based on an intermediate discovery key, where the relay discovery key includes at least one of the following:
an encryption key (DUCK), used to encrypt and decrypt a discovery message of relay communication; or
an integrity assurance key (DUIK), used to protect integrity of the discovery message of relay communication.

An example of the disclosure provides a relay communication apparatus, performed by second UE, and including:
a third processing module, configured to determine a relay discovery key based on an intermediate discovery key and an algorithm identity; or
the third processing module, configured to determine the relay discovery key based on the intermediate discovery key, the algorithm identity and an RSC.

An example of the disclosure provides a relay communication apparatus, performed by second UE, and including:
a third receiving module, configured to receive a first announcement message, where the first announcement message includes: a discovery message encrypted based on a relay discovery key and subjected to integrity protection; and the discovery message is used to indicate that first UE supports being discovered to provide a relay service; and
a third processing module, configured to obtain the discovery message by decrypting and verifying the first announcement message based on the relay discovery key.

An example of the disclosure provides a relay communication apparatus, performed by second UE, and including: a third sending module 41, configured to send a second announcement message, where the second announcement message includes: a discovery request message encrypted based on a relay discovery key and subjected to integrity protection; and the discovery request message is used to request the second UE to discover a requested relay service.

An example of the disclosure provides a relay communication apparatus, performed by second UE, and including:
a third receiving module, configured to receive a third announcement message, where the third announcement message includes: a discovery response message encrypted based on a relay discovery key and subjected to integrity protection, where the discovery response message is determined based on a discovery request message; and
a third processing module, configured to obtain the discovery response message by decrypting and verifying the third announcement message based on the relay discovery key.

An example of the disclosure provides a relay communication apparatus, performed by second UE, and including: a third receiving module, configured to receive a second RSC set sent by a second AMF, where the second RSC set includes: at least one second RSC; and the second RSC is an RSC of a relay service that is able to be obtained by the second UE.

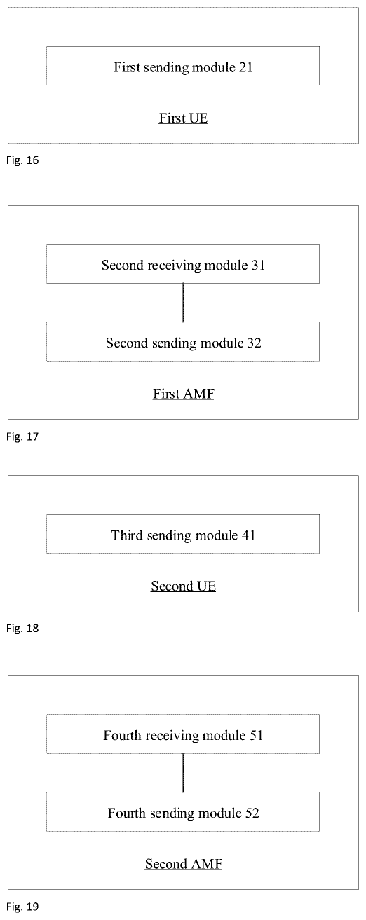

As shown in FIG. 19, an example of the disclosure provides a relay communication apparatus, performed by a second AMF, and including:
a fourth receiving module 51, configured to receive a third request message sent by second user equipment (UE), where the third request message is used to request security information for relay communication discovery between first UE and the second UE; and
a fourth sending module 52, configured to send, based on third identification information of the second UE carried in the third request message, a fourth request message for requesting the security information to a second policy control function (PCF) corresponding to the third identification information.

An example of the disclosure provides a relay communication apparatus, performed by a second AMF, and including:
a fourth receiving module 51, configured to receive a fourth response message sent by a second PCF, where the fourth response message includes security information; and
a fourth sending module 52, configured to send, based on fourth identification information of second UE carried in the fourth response message, a third response message carrying the security information to the second UE.

An example of the disclosure provides a relay communication apparatus, performed by a second AMF, and including: a fourth processing module, configured to determine, based on third identification information and a second mapping relationship, fourth identification information corresponding to second UE, where the second mapping relationship includes a correspondence between the third identification information and the fourth identification information.

In some examples, the third identification information includes at least one of the following: an SUCI or a GUTI; and
the fourth identification information includes an SUPI.

In some examples, a fourth request message includes: a message related to key request; a fourth response message includes: a message related to key response; and security information includes: an intermediate discovery key.

In some examples, the message related to key request includes: a relay service code (RSC) indicating a relay service; and
the message related to key response includes: an intermediate discovery key for the RSC, or the intermediate discovery key for the RSC and identification information of the intermediate discovery key.

An example of the disclosure provides a relay communication apparatus, performed by a second AMF, and including:
a fourth receiving module 51, configured to receive a second RSC set sent by a second PCF, where the second RSC set includes: at least one second RSC; and the second RSC is an RSC of a relay service that is able to be obtained by second UE; and
a fourth sending module 52, configured to send the second RSC set to second UE.

As shown in FIG. 20, an example of the disclosure provides a relay communication apparatus, performed by a first PCF, and including:
a fifth receiving module 61, configured to receive a second request message sent by a first AMF and/or receive a fourth request message sent by a second PCF, where the second request message and/or the fourth request message are/is used to request security information for relay communication discovery between first UE and second UE.

In some examples, the second request message includes second identification information of the first UE.

An example of the disclosure provides a relay communication apparatus, performed by a first PCF, and including: a fifth sending module, configured to send a second response message to a first AMF, where the second response message includes second identification information and a second response message of the security information.

In some examples, the fourth request message includes fourth identification information of the second UE.

An example of the disclosure provides a relay communication apparatus, performed by a first PCF, and including: a fifth sending module, configured to send a fourth response message to a second PCF, where the fourth response message includes fourth identification information and a fourth response message of security information.

In some examples, a second request message and/or a fourth request message include/includes: a message related to key request; a second response message and/or the fourth response message include/includes: a message related to key response; and the security information includes: an intermediate discovery key.

In some examples, the message related to key request includes: an RSC indicating a relay service; and
the message related to key response includes: an intermediate discovery key for the RSC, or an intermediate information key for the RSC and identification information of the intermediate information key.

An example of the disclosure provides a relay communication apparatus, performed by a first PCF, and including: a fifth sending module, configured to send a message related to key response to a second PCF in response to determining that first UE is authorized to provide a relay service to second UE.

An example of the disclosure provides a relay communication apparatus, performed by a first PCF, and including: a fifth receiving module, configured to send a first RSC set to a first AMF, where the first RSC set includes: at least one first RSC; and the first RSC is an RSC of a relay service that is able to be provided by the first UE.

As shown in FIG. 21, an example of the disclosure provides a relay communication apparatus, performed by a second PCF, and including:
a sixth receiving module 71, configured to receive a fourth request message sent by a second AMF, where the fourth request message is used to request security information for relay communication discovery between first user equipment (UE) and second UE; and
a sixth sending module 72, configured to send the fourth request message for requesting the security information to a first PCF.

An example of the disclosure provides a relay communication apparatus, performed by a second PCF, and including: a sixth sending module 62, configured to send, in response to determining to authorize second UE to discover a relay service, a fourth request message for requesting security information to a first PCF.

In some examples, the fourth request message includes fourth identification information of the second UE.

An example of the disclosure provides a relay communication apparatus, performed by a second PCF, and including: a sixth sending module 62, configured to send a fourth response message to a first AMF, where the fourth response message includes fourth identification information and security information.

In some examples, a fourth request message includes: a message related to key request; the fourth response message includes: a message related to key response; and the security information includes: an intermediate discovery key.

In some examples, the message related to key request includes: an RSC indicating a relay service; and
the message related to key response includes: an intermediate discovery key for the RSC, or the intermediate discovery key for the RSC and identification information of the intermediate discovery key.

An example of the disclosure provides a relay communication apparatus, performed by a second PCF, and including: a sixth sending module 62, configured to send a second RSC set to a second AMF, where the second RSC set includes: at least one second RSC; and the second RSC is an RSC of a relay service that is able to be obtained by second UE.

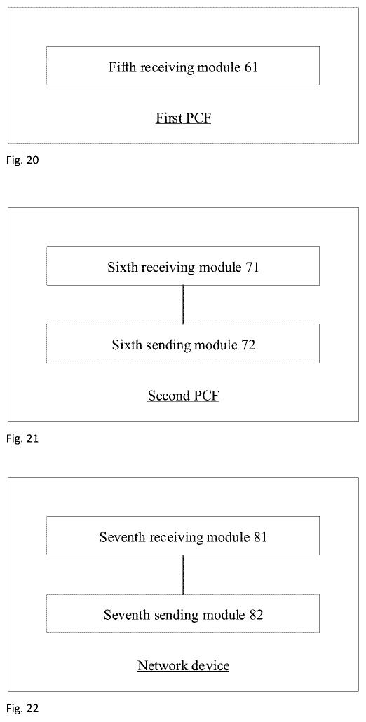

As shown in FIG. 22, an example of the disclosure provides a relay communication apparatus, applied to a network device, and including:
a seventh receiving module 81, configured to acquire a request message sent by UE, where the request message carries identification information of the UE, and the request message is used to request security information for relay communication discovery between the UE and UE; and
a seventh sending module 82, configured to send a response message carrying the security information to the UE.

An example of the disclosure provides a relay communication apparatus, applied to a network device, and the network device includes a first AMF and a first PCF, where
a first request message sent by first UE is acquired by the first AMF; and based on first identification information carried in the first request message, a second request message carrying second identification information is sent to the first PCF, where the first request message and/or the second request message are/is used to request security information for relay communication discovery between the first UE and second UE; and
a second response message sent by the first PCF is acquired by the first AMF, and based on second identification information of the second response message, the first response message is sent to the first UE, where the first response message and/or the second response message carry/carries the security information.

In some examples, the first request message and/or the second request message include/includes: a relay service code (RSC) indicating a relay service; and
the first response message and/or the second response message include/includes: an intermediate discovery key for the RSC, or the intermediate discovery key for the RSC and identification information of the intermediate discovery key.

An example of the disclosure provides a relay communication apparatus, applied to a network device, and the network device includes a second AMF, a first PCF and a second PCF, where
a third request message sent by second UE is acquired by the second AMF; and based on third identification information carried in the third request message, a fourth request message carrying fourth identification information is sent to the second PCF, where the third request message and/or the fourth request message are/is used to request security information for relay communication discovery between first UE and the second UE;
the fourth request message is sent to the first PCF by the second PCF;
a fourth response message is sent to the second PCF by the first PCF; and
the fourth response message sent by the second PCF is acquired by the second AMF, and based on fourth identification information of the fourth response message, a third response message is sent to the second UE, where the third response message and/or the fourth response message carry/carries the security information.

An example of the disclosure provides a relay communication apparatus, applied to a network device, and the network device includes a first PCF and a second PCF, where
it is determined by the second PCF to authorize second UE to discover a relay service and send a fourth request message to the first PCF; and
it is determined by the first PCF to authorize first UE to provide the relay service to second UE, and send a fourth response message to the second PCF.

In some examples, the third request message and/or the fourth request message include/includes: an RSC indicating a relay service; and
a third response message and/or the fourth response message include/includes: an intermediate discovery key for the RSC, or the intermediate discovery key for the RSC and identification information of the intermediate discovery key.

It is to be noted that those skilled in the art may understand that the apparatus provided by the examples of the disclosure may be performed separately, or performed together with some apparatuses in the examples of the disclosure, or some apparatuses in the related art.

As for the apparatus in the above examples, the specific manners for executing operations by each module have be described in the examples related to the method in detail, which is not illustrated in detail here.

An example of the disclosure provides a communication device, including:
a processor; and
a memory, configured to store executable instructions of the processor, where
the processor is configured to: implement the relay communication method described in any example of the disclosure when running the executable instructions.

In an example, the communication device may include, but is not limited to at least one of a core network device, an access network device, and UE. The UE may be the first UE or the second UE in the above examples; and the core network device may be the first AMF, the second AMF, the first PCF, or the second PCF in the above examples.

The processor may include various types of storage media, which are non-transitory computer storage media that can continue to memorize information stored on it after the user equipment is powered down.

The processor may be connected with the memory through a bus or the like, for reading an executable program stored on the memory, such as at least one of the methods shown in FIG. 4 to FIG. 15.

An example of the disclosure further provides a non-transitory computer storage medium. The non-transitory computer storage medium stores a computer executable program. The executable program, when executed by a processor, implements relay communication method according to any example of the disclosure, such as at least one of the methods shown in FIG. 4 to FIG. 15.

As for the apparatus or the storage medium in the above examples, the specific manners for executing operations by each module have be described in the examples related to the method in detail, which is not illustrated in detail here.

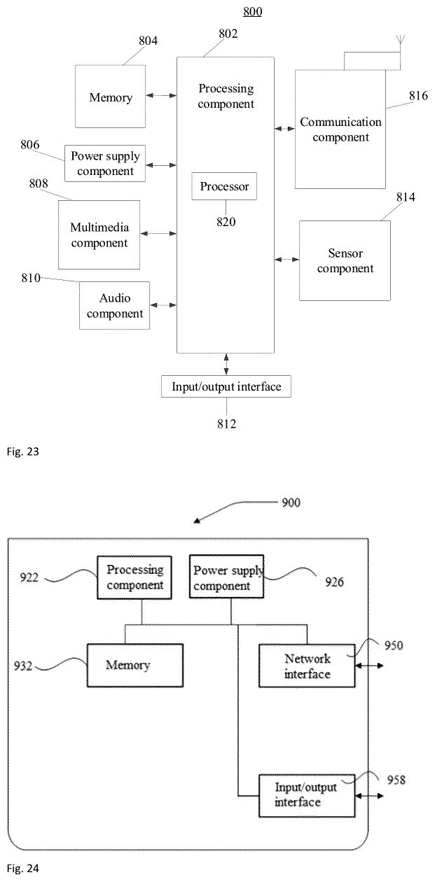

FIG. 23 is a block diagram of user equipment 800 shown according to an example. For example, the user equipment 800 may be a mobile telephone, a computer, digital broadcast user equipment, a message transceiving device, a game console, a tablet device, a medical device, a fitness device, a personal digital assistant, and the like.

Referring to FIG. 23, the user equipment 800 may include one or more of the following components: a processing component 802, a memory 804, a power supply component 806, a multimedia component 808, an audio component 810, an input/output (I/O) interface 812, a sensor component 814, and a communication component 816.

The processing component 802 usually controls overall operations of the user equipment 800, such as operations associated with displaying, telephone calling, data communication, a camera operation and a record operation. The processing component 802 may include one or more processors 820 to execute an instruction, so as to complete all or part of steps of the above method. In addition, the processing component 802 may include one or more modules, so as to facilitate interaction between the processing component 802 and other components. For example, the processing component 802 may include a multimedia module, so as to facilitate interaction between the multimedia component 808 and the processing component 802.

The memory 804 is configured to store various types of data so as to support operations on the user equipment 800. Examples of these data include instructions of any application programs or methods used to be operated on the user equipment 800, contact data, telephone directory data, messages, pictures, videos, and the like. The memory 804 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 806 provides electric power for various components of the user equipment 800. The power supply component 806 may include a power management system, one or more power sources, and other components associated with generating, managing and distributing electric power for the user equipment 800.

The multimedia component 808 includes a screen providing an output interface between the user equipment 800 and a user. In some examples, the screen may include a liquid crystal display (LCD) and a touch panel (TP). In response to determining that the screen includes the touch panel, the screen may be implemented as a touch screen so as to receive an input signal from the user. The touch panel includes one or more touch sensors to sense touching, swiping and gestures on the touch panel. The touch sensor may not only sense a boundary of a touching or swiping action, but also detect duration and pressure related to the touching or swiping operation. In some examples, the multimedia component 808 includes a front camera and/or a back camera. When the user equipment 800 is in an operation mode, such as a shooting mode or a video mode, the front camera and/or the back camera may receive external multimedia data. Each front camera and each back camera may be a fixed optical lens system or have a focal length and optical zooming capability.

The audio component 810 is configured to output and/or input an audio signal. For example, the audio component 810 includes a microphone (MIC). When the user equipment 800 is in the operation mode, such as a call mode, a recording mode or a speech recognition mode, the microphone is configured to receive an external audio signal. The received audio signal may be further stored in the memory 804 or sent via the communication component 816. In some examples, the audio component 810 further includes a speaker for outputting the audio signal.

The I/O interface 812 provides an interface between the processing component 802 and a peripheral interface module, and the above peripheral interface module may be a keyboard, a click wheel, buttons, etc. These buttons may include but are not limited to: a home button, a volume button, a start button and a lock button.

The sensor component 814 includes one or more sensors for providing state evaluations of all aspects for the user equipment 800. For example, the sensor component 814 may detect an on/off state of the equipment 800 and relative positioning of components, for example, the components are a display and a keypad of the user equipment 800. The sensor component 814 may further detect position change of the user equipment 800 or one component of the user equipment 800, whether there is contact between the user and the user equipment 800, azimuth or speed up/speed down of the user equipment 800, and temperature change of the user equipment 800. The sensor component 814 may include a proximity sensor, which is configured to detect existence of a nearby object without any physical contact. The sensor component 814 may further include an optical sensor, such as a CMOS or CCD image sensor, for use in an imaging application. In some examples, the sensor component 814 may further include an acceleration sensor, a gyroscope sensor, a magnetic sensor, a pressure sensor or a temperature sensor.

The communication component 816 is configured to facilitate wired or wireless communication between the user equipment 800 and other devices. The user equipment 800 may access into a wireless network based on a communication standard, such as WiFi, 4G or 5G, or their combination. In one example, the communication component 816 receives a broadcast signal or broadcast related information from an external broadcast management system via a broadcast channel. In an example, the communication component 816 further includes a near-field communication (NFC) module so as to facilitate short-range communication. For example, the NFC module may be implemented based on a radio frequency identification (RFID) technology, an infrared data association (IrDA) technology, an ultra wide band (UWB) technology, a Bluetooth (BT) technology and other technologies.

In the example, the user equipment 800 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for executing the above method.

In the example, a non-transitory computer readable storage medium including instructions is further provided, such as a memory 804 including instructions. The above instructions may be performed by a processor 820 of the user equipment 800 so as to complete the above method. For example, the non-temporary computer readable storage medium may be an ROM, a random access memory (RAM), a CD-ROM, a magnetic tape, a floppy disk, an optical data storage device and the like.

As shown in FIG. 24, an example of the disclosure shows a structure of a base station. For example, the base station 900 may be provided as a network-side device. Referring to FIG. 24, the base station 900 includes a processing component 922, which further includes one or more processors, and a memory resource represented by a memory 932, for storing instructions executable by the processing component 922, such as an application program. The application program stored in the memory 932 may include one or more modules with each corresponding to a set of instructions. In addition, the processing component 922 is configured to execute the instructions so as to execute any of the aforementioned methods applied to the base station.

The base station 900 may further include a power supply component 926 configured to execute power management of the base station 900, a wired or wireless network interface 950 configured to connect the base station 900 to a network, and an input/output (I/O) interface 958. The base station 900 may operate based on an operating system stored in a memory 932, such as Windows Server™, Mac OS X™, Unix™, Linux™, FreeBSD™ or the like.

The technical solution provided by the examples of the disclosure may include the following beneficial effects:
in the example of the disclosure, the first request message may be sent to the first AMF through the first UE, where the first request message is used to request security information for relay communication discovery between the first UE and the second UE, the first request message includes the first identification information of the first UE, and the first identification information is used by the first AMF to send the second request information for requesting the security information to the first PCF corresponding to the first UE. In this way, when the relay communication discovery is performed between the first UE and the second UE, security protection may be performed based on this security information. In this way, compared to a approach of not being able to perform security protection during the relay communication discovery, this may make the relay communication discovery between the first UE and the second UE more secure. Moreover, since the first identification information of the first UE is carried in the first request message, the first AMF may be made to accurately know which first UE needs to acquire the security information for the relay communication discovery; and it is beneficial for the first AMF to obtain the security information and then send the same to the first UE.

Those of skill in the art will easily figure out other implementation solutions of the disclosure after considering the specification and practicing the invention disclosed here. The disclosure intends to cover any transformation, usage or adaptive change of the disclosure, and these transformations, usages or adaptive changes conform to a general principle of the disclosure and include common general knowledge or conventional technical means which are not disclosed here in the technical field. The specification and the examples are merely regarded as an example, and the true scope and spirit of the disclosure are indicated by the following claims.

It will be appreciated that the disclosure is not limited to the exact construction that has been described above and shown in the accompanying drawings, and that various modifications and changes may be made without departing from its scope. It is intended that the scope of the disclosure merely be limited by the appended claims.

1. A relay communication method, performed by first user equipment (UE), the relay communication method comprising:
sending a first request message to a first access and mobility management function (AMF), wherein the first request message is used to request security information for relay communication discovery between the first UE and second UE;
wherein, the first request message comprises first identification information of the first UE, and the first identification information is used by the first AMF to send second request information for requesting the security information to a first policy control function (PCF) corresponding to the first UE.

2. The relay communication method according to claim 1, wherein the relay communication method further comprises:
receiving a first response message sent by the first AMF, wherein the first response message comprises: the security information comprised in a second response message, and the second response message is sent by the first PCF based on second identification information of the first UE comprised in the second response message.

3. The relay communication method according to claim 2, wherein the first identification information comprises at least one of the following:
a subscription concealed identifier (SUCI); or
a globally unique temporary UE identity (GUTI);
and/or,
the second identification information comprises a subscription permanent identifier (SUPI) corresponding to the first identification information;
wherein the first request message comprises: a message related to key request; the first response message comprises: a message related to key response; and the security information comprises: an intermediate discovery key;
wherein the message related to key request comprises: a relay service code (RSC) indicating a relay service; and
the message related to key response comprises: the intermediate discovery key for the RSC, or the intermediate discovery key for the RSC and identification information of the intermediate discovery key;
wherein the message related to key request further comprises at least one of the following:
a type indication information, used to indicate a type of a discovery message of relay communication; or
a first security indication information, used to indicate a security capability of the first UE;
wherein the message related to key response further comprises at least one of the following:
an algorithm identity, wherein the algorithm identity comprises at least one of the following: a first algorithm identity, used to indicate an algorithm for encrypting and decrypting a discovery message of relay communication; or a second algorithm identity, used to indicate an algorithm for protecting integrity of a discovery message of relay communication; or
a time related information, used to determine whether a discovery message of relay communication is subjected to replay attack.

4-7. (canceled)

8. The relay communication method according to claim 3, wherein the relay communication method further comprises:
determining a relay discovery key based on the intermediate discovery key, wherein the relay discovery key comprises at least one of the following:
an encryption key (Discovery User Confidentiality Key, DUCK), used to encrypt and decrypt a discovery message of relay communication; or
an integrity assurance key (Discovery User Integrity Key, DUIK), used to protect integrity of the discovery message of relay communication;
wherein determining the relay discovery key based on the intermediate discovery key comprises at least one of the following:
determining the relay discovery key based on the intermediate discovery key and an algorithm identity; or
determining the relay discovery key based on the intermediate discovery key, the algorithm identity and an RSC; and
wherein the relay communication method further comprises:
receiving a first RSC set sent by the first AMF, wherein the first RSC set comprises: at least one first RSC; and the at least one first RSC is an RSC of a relay service that is able to be provided by the first UE.

9. (canceled)

10. The relay communication method according to claim 8, wherein the relay communication method further comprises at least one of the following:
sending a first announcement message, wherein the first announcement message comprises: the discovery message encrypted based on the relay discovery key and subjected to integrity protection; and the discovery message is used to indicate that the first UE supports being discovered to provide a relay service;
receiving a second announcement message, wherein the second announcement message comprises: a discovery request message encrypted based on the relay discovery key and subjected to integrity protection; and the discovery request message is used to request the second UE to discover the requested relay service; and obtaining the discovery request message by decrypting and verifying the second announcement message based on the relay discovery key; or
sending a third announcement message, wherein the third announcement message comprises: a discovery response message encrypted based on the relay discovery key and subjected to integrity protection, wherein the discovery response message is determined based on the discovery request message.

11-13. (canceled)

14. A relay communication method, performed by a first access and mobility management function (AMF), the relay communication method comprising:
receiving a first request message sent by first user equipment (UE), wherein the first request message is used to request security information for relay communication discovery between the first UE and second UE; and
sending, based on first identification information of the first UE carried in the first request message, a second request message for requesting the security information to a first policy control function (PCF) corresponding to the first identification information.

15. The relay communication method according to claim 14, wherein the relay communication method further comprises:
receiving a second response message sent by the first PCF, wherein the second response message comprises the security information; and
sending, based on second identification information of the first UE carried in the second response message, a first response message carrying the security information to the first UE.

16. The relay communication method according to claim 15, wherein the relay communication method further comprises:
determining, based on the first identification information and a first mapping relationship, the second identification information corresponding to the first UE, wherein the first mapping relationship comprises a correspondence between the first identification information and the second identification information; and
receiving a first RSC set sent by the first PCF, wherein the first RSC set comprises: at least one first RSC; and the at least one first RSC is an RSC of a relay service that is able to be provided by the first UE; and sending the first RSC set to the first UE.

17. The relay communication method according to claim 15, wherein
the first identification information comprises at least one of the following: a subscription concealed identifier (SUCI), or a globally unique temporary UE identity (GUTI);
the second identification information comprises a subscription permanent identifier (SUPI);
the second request message comprises: a message related to key request; the second response message comprises: a message related to key response; the security information comprises: an intermediate discovery key;
the message related to key request comprises: a relay service code (RSC) indicating a relay service; and
the message related to key response comprises: the intermediate discovery key for the RSC, or the intermediate discovery key for the RSC and identification information of the intermediate discovery key.

18-40. (canceled)

41. A relay communication method, performed by a first policy control function (PCF), the relay communication method comprising:
receiving a second request message, the second request message is sent by a first access and mobility management function (AMF) according to the relay communication method of claim 14; and/or
receiving a fourth request message sent by a second PCF, wherein the second request message and/or the fourth request message are/is used to request security information for relay communication discovery between first user equipment (UE) and second UE; the second PCF is a PCF corresponding to the second UE.

42. The relay communication method according to claim 41, wherein the second request message comprises second identification information of the first UE; and
the relay communication method further comprises:
sending a second response message to the first AMF, wherein the second response message comprises the second identification information and the security information.

43. The relay communication method according to claim 41, wherein the fourth request message comprises fourth identification information of the second UE; and
the relay communication method further comprises:
sending a fourth response message to the second PCF, wherein the fourth response message comprises the fourth identification information and the security information.

44. The relay communication method according to claim 41, wherein the second request message and/or the fourth request message comprise/comprises: a message related to key request; the second response message and/or the fourth response message comprise/comprises: a message related to key response; and the security information comprises: an intermediate discovery key;
the message related to key request comprises: a relay service code (RSC) indicating a relay service; and
the message related to key response comprises: the intermediate discovery key for the RSC, or intermediate information key for the RSC and identification information of the intermediate information key.

45. (canceled)

46. The relay communication method according to claim 44, wherein sending the fourth response message to the second PCF comprises:
sending the message related to key response to the second PCF in response to determining that the first UE is authorized to provide a relay service to the second UE; and
wherein the relay communication method further comprises:
sending a first RSC set to the first AMF, wherein the first RSC set comprises: at least one first RSC; and the first RSC is an RSC of a relay service that is able to be provided by the first UE.

47-53. (canceled)

54. A relay communication method, performed by a network device, the relay communication method comprising:
acquiring a request message sent by user equipment (UE), wherein the request message carries identification information of the UE, and the request message is used to request security information for relay communication discovery between the UE and another UE; and
sending a response message carrying the security information to the UE.

55. The relay communication method according to claim 54, wherein the network device comprises: a first AMF and a first PCF;
acquiring the request message sent by the user equipment (UE) comprises:
acquiring, by the first AMF, a first request message sent by a first UE; and sending, based on first identification information carried in the first request message, a second request message carrying second identification information to the first PCF, wherein the first request message and/or the second request message are/is used to request the security information for relay communication discovery between the first UE and a second UE; and
sending the response message carrying the security information to the UE comprises:
acquiring, by the first AMF, a second response message sent by the first PCF, and sending, based on second identification information of the second response message, a first response message to the first UE, wherein the first response message and/or the second response message carry/carries the security information;
wherein the first request message and/or the second request message comprise/comprises: a relay service code (RSC) indicating a relay service; and
the first response message and/or the second response message comprise/comprises: an intermediate discovery key for the RSC, or the intermediate discovery key for the RSC and identification information of the intermediate discovery key.

56. (canceled)

57. The relay communication method according to claim 54, wherein the network device comprises: a second AMF, a first PCF and a second PCF;
acquiring the request message sent by the user equipment (UE) comprises:
acquiring, by the second AMF, a third request message sent by a second UE; and sending, based on third identification information carried in the third request message, a fourth request message carrying fourth identification information to the second PCF, wherein the third request message and/or the fourth request message are/is used to request the security information for relay communication discovery between a first UE and the second UE; and
sending, by the second PCF, the fourth request message to the first PCF; and
sending the response message carrying the security information to the UE comprises:
sending, by the first PCF, a fourth response message to the second PCF; and
acquiring, by the second AMF, the fourth response message sent by the second PCF, and sending, based on fourth identification information of the fourth response message, a third response message to the second UE, wherein the third response message and/or the fourth response message carry/carries the security information.

58. The relay communication method according to claim 57, wherein sending, by the second PCF, the fourth request message to the first PCF comprises:
determining, by the second PCF, to authorize the second UE to discover a relay service and send the fourth request message to the first PCF; and
sending, by the first PCF, the fourth response message to the second PCF comprises:
determining, by the first PCF, to authorize the first UE to provide the relay service to the second UE, and send the fourth response message to the second PCF;
wherein the third request message and/or the fourth request message comprise/comprises: an RSC indicating a relay service; and
the third response message and/or the fourth response message comprise/comprises: an intermediate discovery key for the RSC, or the intermediate discovery key for the RSC and identification information of the intermediate discovery key.

59-65. (canceled)

66. A communication device, wherein the communication device comprises:
one or more processors; and
a memory for storing executable instructions of the one or more processors;
wherein the executable instructions when executed by the one or more processors, cause the one or more processors to perform the relay communication method according to claim 1.

67. A non-transitory computer storage medium, wherein the non-transitory computer storage medium stores a computer executable program, and the computer executable program, when executed by one or more processors, causes the one or more processors to perform the relay communication method according to claim 1.
